(19) United States
(12) Patent Application Publication
(10) Pub. No.: US 2018/0091296 A1
(43) Pub. Date: Mar. 29, 2018

(54) CRYTOGRAPHIC PROCESSING

(71) Applicant: IRDETO B.V., Hoofddorp (NL)

(72) Inventors: HAROLD JOHNSON, Ottawa (CA); JEROEN DOUMEN, Hoofddorp (NL); MICHAEL WIENER, Ottawa (CA)

(73) Assignee: IRDETO B.V., HOOFDDORP (NL)

(21) Appl. No.: 15/562,428

(22) PCT Filed: Mar. 30, 2016
(86) PCT No.: PCT/EP2016/056895

§ 371 Date: Sep. 28, 2017

(30) Foreign Application Priority Data
Mar. 30, 2015 (GB) 1505434.9

(51) Int. Cl. H04L 9/06; H04L 9/14

(52) U.S. Cl. CPC H04L 9/0631; H04L 9/14

(57) ABSTRACT

A cryptographic method comprising sequentially performing a number of rounds, each round comprising performing a respective round function on respective input data for that round to generate respective output data for that round, wherein for each of the second and subsequent rounds, the input data for that round is the output data of the preceding round, wherein for each round the respective round function comprises: applying a respective bijective operation to a first amount of data to produce a first result, the bijective operation corresponding to at least part of a cryptographic key; and processing a second amount of data by applying a plurality of processing operations to produce a second result, wherein at least one of the processing operations is the bijective operation; wherein the first amount of data and the second amount of data are based on the input for said round and wherein the output data for said round is based on the first result and the second result; wherein one or both of the following apply: (a) for each of one or more of the processing operations, that processing operation comprises functionality that is dependent on a respective part of the first result; and (b) for each of one or more of the processing operations, a number of times that processing operation is applied when processing the second amount of data is dependent on a respective part of the first result.

### FIELD OF THE INVENTION

The present invention relates to a cryptographic method, devices and computer programs for carrying out such a cryptographic method, methods and apparatus for creating such devices, and different uses of such cryptographic methods, devices and computer programs.

### BACKGROUND OF THE INVENTION

Various cryptographic algorithms are well-known, such as the AES encryption algorithm (see http://csrc.nist.gov/publications/fips/fips197/fips-197.pdf). Such cryptographic algorithms are used for providing security related functionality (such as encryption of data, generation of message authentication codes, etc.).

Many implementations of such algorithms are easily copied. This is true for hardware implementations too, where devices that implement a cryptographic algorithm using a particular cryptographic key may be cloned in order to produce duplicate/identical devices. Often, once one hardware device has been successfully attacked (or “hacked”), it becomes relatively straightforward to successfully attack other similar hardware devices. Often, implementations are easily attacked so as to identify a secret key embedded within the implementation once this secret key has been identified by an attacker, the attacker can distribute that key to others, thereby potentially causing damage, lost revenue, data leakage, etc. Examples of such attacks against hardware devices include side-channel attacks and differential power analysis.

It would be desirable to be able to provide similar cipher-like functionality in a manner that uses only a small number of hardware or software resources (so that they are cheap to manufacture or implement and run), is easily configurable with cryptographic keys, whilst being hard to reverse engineer or attack.

### SUMMARY OF THE INVENTION

According to a first aspect of the invention, there is provided a cryptographic method comprising sequentially performing a number of rounds, each round comprising performing a respective round function on respective input data for that round to generate respective output data for that round, wherein for each of the second and subsequent rounds, the input data for that round is the output data of the preceding round, wherein for each round the respective round function comprises: applying a respective bijective operation to a first amount of data to produce a first result, the bijective operation corresponding to at least part of a cryptographic key; and processing a second amount of data by applying a plurality of processing operations to produce a second result, wherein at least one of the processing operations is the bijective operation; wherein the first amount of data and the second amount of data are based on the input for said round and wherein the output data for said round is based on the first result and the second result; wherein one or both of the following apply: (a) for each of one or more of the processing operations, that processing operation comprises functionality that is dependent on a respective part of the first result; and (b) for each of one or more of the processing operations, a number of times that processing operation is applied when processing the second amount of data is dependent on a respective part of the first result.

In some embodiments, said processing operation that is the bijective operation is one of the one or more processing operations for which a number of times that processing operation is applied when processing the second amount of data is dependent on a respective part of the first result.

In some embodiments, at least one of said one or more processing operations that comprises functionality that is dependent on a respective part of the first result is an operation that cyclically rotates elements of an input to said operation by a number of elements dependent on said respective part of the first result.

In some embodiments, at least one of said one or more processing operations that comprises functionality that is dependent on a respective part of the first result is an operation that inverts one or more elements of an input to said operation, the one or more elements being selected based on said respective part of the first result.

The above-mentioned elements may be bits.

In some embodiments, the bijective operation is arranged to bijectively map an n-bit input value to an n-bit output value by sequentially using Ns sets Sᵢ (i=1, . . . , Ns) of bijective mappings, each set Sᵢ (i=1, . . . , Ns) having a respective number Nbᵢ of respective bijective mappings B_{i,1}, . . . , B_{i,Nb}_{ᵢ}, wherein each bijective mapping B_{i,j} (i=1, . . . , Ns, j=1, . . . , Nbᵢ) is arranged to bijectively map an input with a respective number w_{i,j} of bits to an output with w_{i,j} bits, wherein for i=1, . . . , Ns, Σⱼ₌₁^{Nb}^{ⁱ} w_{i,j}=n, wherein: for set S₁, the input for the bijective mapping B_{i,j} (j=1, . . . , Nb₁) is formed from w_{1,j} bits from the n-bit input value selected according to at least part of the cryptographic key; for set Sᵢ (i=2, . . . , Ns), the input for the bijective mapping B_{i,j} (j=1, . . . , Nbᵢ) comprises w_{i,j} bits from the outputs of the bijective mappings B_{i-1,1}, . . . , B_{i-1,Nb}_{ᵢ₋₁}; the n-bit output value comprises the bits from the outputs of the bijective mappings B_{Ns,1}, . . . , B_{Ns,Nb}_{_{Ns}} arranged according to at least part of the cryptographic key. In some embodiments: n=27, Ns=3, Nbᵢ=9 (for i=1, 2, 3) and w_{i,j}=3 (for i=1, 2, 3 and j=1, . . . , 9).

The sets of bijective mappings may form a Banyan network.

The sets of bijective mappings may be arranged so that each bit of the n-bit input value affects substantially all of the bits of the n-bit output value.

In some embodiments, each bijective mapping B_{i,j} (i=1, . . . , Ns, j=1, . . . , Nbᵢ) may be based on at least part of the cryptographic key.

In some embodiments, the output data of said round comprises the first result and the second result. The output data of said round may comprise N bits, wherein N is an even number and wherein the first result and the second result comprise N/2 respective bits for the output data.

In some embodiments, the input data of said round comprises the first amount of data and the second amount of data. The input data of said round may comprise N bits, wherein N is an even number and wherein the first amount of data and the second amount of data comprise N/2 bits respective bits from the input data.

In some embodiments, N=54.

In some embodiments, for each round the respective round function further comprises performing a respective bijective function on a respective input chunk of data to generate a respective output chunk of data, wherein the input chunk of data is based on the input for said round and wherein the first amount of data and the second amount of data for said round are based on the output chunk of data.

Then, in some embodiments, the input chunk of data and the output chunk of data are m-bit values, wherein the bijective function uses a respective set of bijective mappings B₁, . . . , B_{Nb}, wherein Nb is a respective positive integer, wherein each bijective mapping Bⱼ (j=1, . . . , Nb) is arranged to bijectively map an input with a respective number wⱼ of bits to an output with wⱼ bits, wherein Σⱼ₌₁^{Nb} wⱼ=m, wherein the input for the bijective mapping Bⱼ (j=1, . . . , Nb) is formed from wⱼ bits from the m-bit input chunk of data and the m-bit output chunk of data comprises the bits from the outputs of the bijective mappings B₁, . . . , B_{Nb}. Then, in some embodiments: m=54, Nb=27 and wⱼ=2 (for j=1, . . . , Nb).

In some embodiments, each bijective mapping Bⱼ (j=1, . . . , Nb) is based on at least part of the cryptographic key.

In some embodiments, the input chunk of data is the input data for said round.

According to a second aspect of the invention, there is provided a device arranged to perform the method of the first aspect of the invention or any embodiment thereof.

According to a third aspect of the invention, there is provided a method of generating a plurality of devices of the second aspect of the invention, the method comprising: for each of the plurality of devices: determining the round function for each round, wherein the set of determined round functions is specific to said device; and generating the device, wherein the device is arranged to perform the method of the first aspect of the invention or any embodiment thereof using the set of determined round functions.

In some embodiments, said generating the device comprises using one of (a) printed electronics; or (b) e-beam lithography.

According to a fourth aspect of the invention, there is provided a method of performing a challenge-response protocol, then method comprising: receiving a challenge; and processing the challenge using a cryptographic method according to the first aspect of the invention or any embodiment thereof to generate a response corresponding the challenge.

According to a fifth aspect of the invention, there is provided a method of performing a challenge-response protocol, then method comprising: generating a challenge; and providing the challenge to a device of the second aspect of the invention, the device arranged to process the challenge using a cryptographic method according to the first aspect of the invention or any embodiment thereof to generate a response corresponding the challenge; and receiving the response from the device.

According to a sixth aspect of the invention, there is provided a method authenticating an article, the method comprising: generating a challenge; and providing the challenge to a device of the second aspect of the invention that is associated with the article, the device arranged to process the challenge using a cryptographic method according to the first aspect of the invention or any embodiment thereof to generate a response corresponding the challenge; receiving the response from the device; and determining whether the response is an expected response.

According to a seventh aspect of the invention, there is provided a method executing an item of software on a data processor, the method comprising, during execution of the item of software: the data processor providing the challenge to a device of the second aspect of the invention that is associated with the data processor, the device arranged to process the challenge using a cryptographic method according to the first aspect of the invention or any embodiment thereof to generate a response corresponding the challenge; and the data processor receiving the response from the device, wherein subsequent execution of the item of software is based, at least in part, on the received response.

According to an eighth aspect of the invention, there is provided an apparatus arranged to carry out a method according to any one of the third to seventh aspects of the invention.

According to a ninth aspect of the invention, there is provided a computer program which, when executed by one or more processors, causes the one or more processors to carry out a method according to any one of the first or third to seventh aspects of the the invention. The computer program may be stored on a computer-readable medium.

### BRIEF DESCRIPTION OF THE DRAWINGS

Embodiments of the invention will now be described, by way of example only, with reference to the accompanying drawings, in which:

FIG. 1 schematically illustrates a cryptographic method according to an embodiment of the invention;

FIG. 2 schematically illustrates a round function Fᵢ according to an embodiment of the invention;

FIGS. 3 and 6 schematically illustrate a function Xᵢ of FIG. 2 according to an embodiment of the invention;

FIG. 4 schematically illustrates a function Yᵢ of FIG. 2 according to an embodiment of the invention;

FIGS. 5 and 7 schematically illustrate a bijective operation Hᵢ of FIG. 4 according to an embodiment of the invention;

FIG. 8 schematically illustrates using the cryptographic method of FIG. 1 to process a block of data according to an embodiment of the invention;

FIG. 9 schematically illustrates an example of a computer system;

FIG. 10 schematically illustrates a system for generating or manufacturing a plurality of devices;

FIG. 11 schematically illustrates a system according to an embodiment of the invention;

FIG. 12 is a flowchart schematically illustrating a method carried out using the system of FIG. 11 according to an embodiment of the invention;

FIG. 13 schematically illustrates a system according to an embodiment of the invention; and

FIGS. 14 and 15 are flowcharts schematically illustrating methods carried out using the system of FIG. 13 according to embodiments of the invention.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### 1—Cryptographic Method

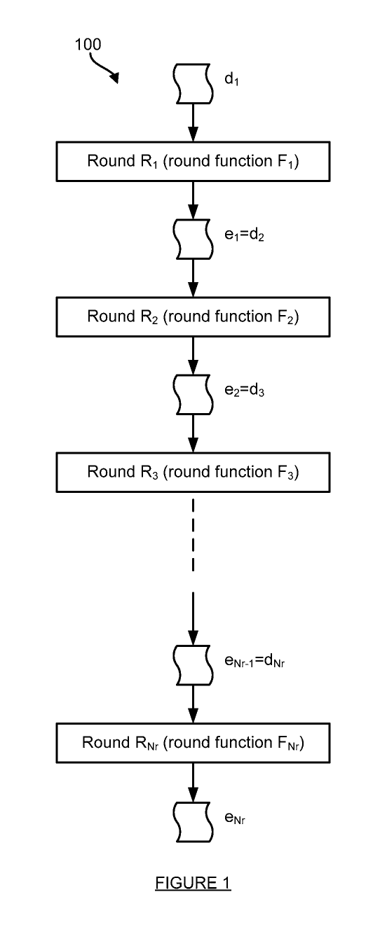

FIG. 1 schematically illustrates a cryptographic method 100 according to an embodiment of the invention.

The method 100 comprises sequentially performing a number of processing rounds (or just “rounds” for short). The number of rounds shall be represented herein by Nr, where Nr is a positive integer. The i^{th} round (i=1, . . . , Nr) shall be represented herein as round Rᵢ. Thus, the method 100 comprises performing (or carrying out or executing), a series of Nr processing stages/steps known as rounds Rᵢ (i=1, . . . , Nr). Preferably Nr=5, but it will be appreciated that embodiments of the invention may make use of other values for Nr.

Each round Rᵢ (i=1, . . . , Nr) comprises performing a respective round function Fᵢ (i=1, . . . , Nr). The round function Fᵢ shall be described in more detail shortly. Each round function Fᵢ (i=1, . . . , Nr) receives (or has as an input, or operates on) respective input data dᵢ (i=1, . . . , Nr) and outputs (or provides or generates) respective output data eᵢ (i=1, . . . , Nr), i.e. eᵢ=Fᵢ(dᵢ). As shown in FIG. 1, for the second and subsequent rounds, i.e. for each of rounds Rᵢ (i=2, . . . , Nr), the input to that round (namely dᵢ) is the output of the preceding round (namely eᵢ₋₁), i.e. dᵢ=eᵢ₋₁ (for i=2, . . . , Nr). Thus, the method 100 is arranged to process input data d₁ to generate output data e_{Nr}.

Each of the inputs dᵢ (i=1, . . . , Nr) and each of the outputs eᵢ (i=1, . . . , Nr) may be considered as respective amounts (or blocks or chunks) of data or as respective data values. Preferably, the size of (i.e. the number of bits for representing) the inputs dᵢ (i=1, . . . , Nr) and the outputs e; (i=1, . . . , Nr) are the same.

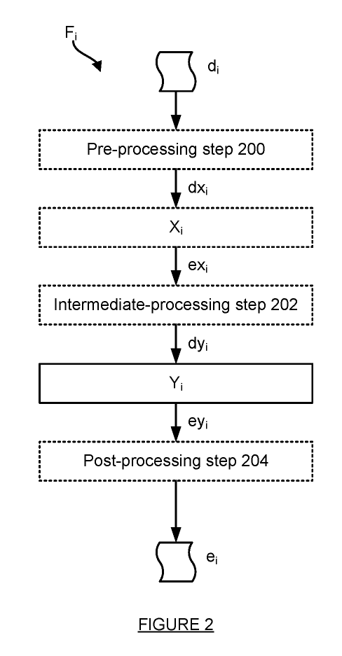

FIG. 2 schematically illustrates a round function Fᵢ according to an embodiment of the invention. This round function Fᵢ (with the structure shown in FIG. 2) is performed at each of the rounds Rᵢ (i=1, . . . , Nr), although the exact configuration (or parameters or settings or arrangement) for the round function Fᵢ shown in FIG. 2 may change or vary from round to round, as will become apparent from the discussion below. However, it will be appreciated that in some embodiments the configuration of the round function Fᵢ for two or more (and possibly all) rounds Rᵢ may be the same as each other, as this would reduce the amount of resources (hardware or code) required to implement the method 100. The configuration of each of the round functions Fᵢ (i=1, . . . , Nr) may be based on, or set by, a cryptographic key ψ for the method 100. Conversely, one may view the configurations for the set of round functions Fᵢ (i=1, . . . , Nr), which could be randomly chosen configurations, as inherently defining a corresponding cryptographic key ψ for the method 100. The relationship between the cryptographic key ψ and the configurations for the round functions Fᵢ (i=1, . . . , Nr) will become apparent from the discussion below.

As shown in FIG. 2, the round function Fᵢ may comprise performing an optional pre-processing step 200 at which one or more operations are performed on the input dᵢ. These one or more operations may be any kind of data processing.

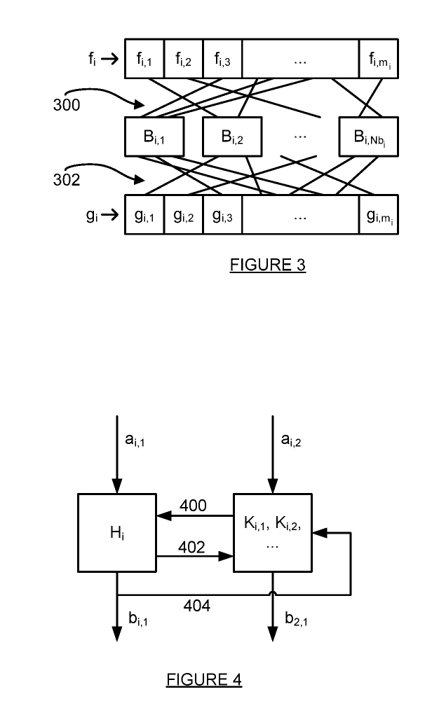

The round function Fᵢ may comprise performing a respective function Xᵢ. If the round function Fᵢ comprises the pre-processing step 200, then the input data dxᵢ processed by the function Xᵢ is the output data produced by the pre-processing step 200. If, on the other hand, the round function Fᵢ does not comprise the pre-processing step 200, then the input data dxᵢ processed by the function Xᵢ is the input dᵢ to the round function F₁. The output of the function Xᵢ is output data exᵢ, i.e. exᵢ=Xᵢ(dxᵢ). The nature of the function Xᵢ shall be described shortly with reference to FIG. 3.

If the round function Fᵢ comprises the function Xᵢ, then the round function Fᵢ may comprise performing an optional intermediate-processing step 202 at which one or more operations are performed on the output data exᵢ. These one or more operations may be any kind of data processing.

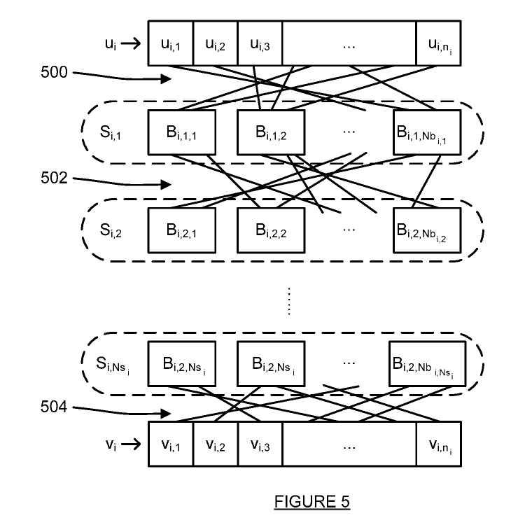

The round function Fᵢ comprises performing a respective function Yᵢ. If the round function Fᵢ comprises the intermediate-processing step 202, then the input data dyᵢ processed by the function Yᵢ is the output data produced by the intermediate-processing step 202. If, on the other hand, the round function Fᵢ does not comprise the intermediate-processing step 202 but does comprise the function Xᵢ, then the input data dye processed by the function Yᵢ is the output data exᵢ of the function Xᵢ. If the round function Fᵢ does not comprise the function Xᵢ but does comprise the pre-processing step 200, then the input data dyᵢ processed by the function Yᵢ is the output data produced by the pre-processing step 200. Otherwise, the input data dye processed by the function Yᵢ is the input dᵢ to the round function Fᵢ. The output of the function Yᵢ is output data eyᵢ, i.e. eyᵢ=Yᵢ(dyᵢ). The nature of the function Yᵢ shall be described shortly with reference to FIGS. 4 and 5.

The round function Fᵢ may comprise performing an optional post-processing step 204 at which one or more operations are performed on the output data eyᵢ. These one or more operations may be any kind of data processing. If the round function Fᵢ comprises the post-processing step 204, then the output eᵢ of the round function Fᵢ is the output of the post-processing step 204. If, on the other hand, the round function Fᵢ does not comprise the post-processing step 204, then the output eᵢ of the round function Fᵢ is the output data eyᵢ, i.e. eᵢ=eyᵢ.

In preferred embodiments of the invention, for each i=1, . . . , Nr, the round function Fᵢ does not include the pre-processing step 200, the intermediate-processing step 202 and the post-processing step 204, as this makes the round functions Fᵢ (i=1, . . . , Nr) more efficient (i.e. quicker to execute). More preferably, in addition, for each i=1, . . . , Nr, the round function Fᵢ does include the function Xᵢ, as this makes the method 100 more secure.

FIG. 3 schematically illustrates the function Xᵢ for the round Rᵢ according to an embodiment of the invention (for i=1, . . . , Nr). As shall become apparent from the discussion below, each function Xᵢ corresponds to, or may define, at least part of the cryptographic key ψ for the method 100.

The function Xᵢ is a bijective function (or operation or mapping) that operates on input data fᵢ (referred to below as an input chunk/block/amount of data fᵢ) to generate output data (referred to below as an output chunk/block/amount of data gᵢ). The function Xᵢ is arranged to bijectively map the input chunk of data fᵢ to the output chunk of data gᵢ. Both the input chunk of data fᵢ and the output chunk of data gᵢ comprise the same number of bits, this number being represented herein as mᵢ, where mᵢ is a positive integer corresponding to the round Rᵢ. This is shown in FIG. 3 with the input chunk of data fᵢ comprising bits f_{i,1}, . . . , f_{i,m}_{ᵢ} and the output chunk of data gᵢ comprising bits g_{i,1}, . . . , g_{i,m}_{ᵢ}.

It will be appreciated that the bijection provided by the function Xᵢ may be implemented in any way, since all that is required is that the function Xᵢ maps the domain of values with mᵢ bits in a 1-to-1 manner to corresponding values with mᵢ bits. This could, for example, be a random mapping (determined by a random number generator seeded by at least part of the cryptographic key ψ for the method 100). However, the architecture/structure shown in FIG. 3 for implementing the function Xᵢ is preferable as it (a) makes efficient use of hardware components (namely individual bijective mappings B_{i,j}); (b) makes it easier to form the function Xᵢ based on the cryptographic key ψ for the method 100 (or, conversely, to determine or identify at least a part of the cryptographic key ψ for the method 100 based on the structure that has been used for the function Xᵢ); and (c) helps improve cryptographic strength by ensuring that bits of the input chunk of data fᵢ can affect a large number of bits of the output chunk of data gᵢ. Thus, the structure shown in FIG. 3 for the function Xᵢ helps improve the cryptographic strength of the method 100 whilst also helping to make it easier to make multiple different instances (i.e. make particular versions or diversified implementations) of the method 100.

As shown in FIG. 3, the implementation of the bijective operation Xᵢ may comprise using a corresponding set of bijective mappings that has a respective number Nbᵢ of respective bijective mappings B_{i,1}, . . . , B_{i,Nb}_{ᵢ}, wherein each bijective mapping B_{i,j} (j=1, . . . , Nbᵢ) is arranged to bijectively map an input with a respective number w_{i,j} of bits to an output value with w_{i,j} bits, wherein Σⱼ₌₁^{Nb}^{ⁱ} w_{i,j}=mᵢ. The input for the bijective mapping B_{i,j} (j=1, . . . , Nbᵢ) is formed from w_{i,j} respective bits from the mᵢ-bit input fᵢ. The input for the bijective mapping B_{i,j} (j=1, . . . , Nbᵢ) may be formed from w_{i,j} respective predetermined (i.e. independent of the cryptographic key ψ) bits from the mᵢ-bit input fᵢ (this being shown as a correspondence, or connecting lines, 300 in FIG. 3) Alternatively, the input for the bijective mapping B_{i,j} (j=1, . . . , Nbᵢ) may be formed from w_{i,j} respective bits selected according to at least part of the cryptographic key ψ. For example, each bit of the input fᵢ may be a corresponding bit of an input for just one of the bijective mappings B_{i,j}, where this correspondence (shown as the connecting lines 300 in FIG. 3) of bits from the input fᵢ to bits of the inputs to the bijective mappings B_{i,j} is dependent on at least part of the cryptographic key ψ of the method 100. Conversely, this correspondence 300 may be viewed as defining or specifying at least part of the cryptographic key ψ. The correspondence 300 may be randomly selected using a random number generator seeded by at least part of the cryptographic key ω.

Similarly, the mᵢ-bit output value gᵢ comprises the mᵢ bits that collectively form the output values of the bijective mappings B_{i,1}, . . . , B_{i,Nb}_{ᵢ}. The mᵢ-bit output value gᵢ may comprise the mᵢ bits of the output values of the bijective mappings B_{i,1}, . . . , B_{i,Nb}_{ᵢ} arranged in a predetermined (i.e. independent of the cryptographic key ψ) order. This arrangement is shown as a correspondence (or connecting lines) 302 in FIG. 3. Alternatively, the mᵢ-bit output value gᵢ may comprise the mᵢ bits of the output values of the bijective mappings B_{i,1}, . . . , B_{i,Nb}_{ᵢ} arranged based on at least part of the cryptographic key ψ for the method 100. For example, each bit of each output value from each of the bijective mappings B_{i,j} (j=1, . . . , Nbᵢ) may be used as a corresponding bit at a corresponding location in the output value gᵢ, where this correspondence (shown as the connecting lines 302 in FIG. 3) of bits from the output of the bijective mappings B_{i,1}, . . . , B_{i,Nb}_{ᵢ} to the bits of the output value gᵢ is dependent on at least part of the cryptographic key ψ of the method 100. Conversely, this correspondence 302 may be viewed as defining or specifying at least part of the cryptographic key ψ. For example, the correspondence 302 may be randomly selected using a random number generator seeded by at least part of the cryptographic key ψ.

For each bijective mappings B_{i,1}, . . . , B_{i,Nb}_{ᵢ}, the actual respective bijection performed by that bijective mapping may be randomly selected using a random number generator seeded by at least part of the cryptographic key q. Conversely, the bijections performed by the respective bijective mappings B_{i,1}, . . . , B_{i,Nb}_{ᵢ} may be viewed as defining or specifying at least part of the cryptographic key q. For example, each bijective mapping B_{i,j} (j=1, . . . , Nbᵢ) may be a respective randomly generated bijection of the set of numbers {0, 1, 2, . . . , 2^{w}^{^{i,j}}−1}.

As is clear from FIG. 2, the input chunk of data fᵢ is based on the input dᵢ for round Rᵢ. Referring back to FIG. 2, the input chunk of data fᵢ is the input dxᵢ and the output chunk of data gᵢ is the output exᵢ.

FIG. 4 schematically illustrates the function Yᵢ of FIG. 2 according to an embodiment of the invention (for i=1, . . . , Nr). As shall become apparent from the discussion below, each function Yᵢ corresponds to, or may define, at least part of the cryptographic key ψ for the method 100.

For the round Rᵢ (for i=1, . . . , Nr), the corresponding function Yᵢ processes two respective amounts of data a_{i,1} and a_{i,2}. The relationship of the two amounts (or chunks or blocks or values) of data a_{i,1} and a_{i,2} to the input dyᵢ (shown in FIG. 2) shall be described later. This processing of the amounts of data a_{i,1} and a_{i,2} generates two results b_{i,1} and b_{i,2}. The relationship of the two results (or chunks/blocks of data or values) b_{i,1} and b_{i,2} to the output eyᵢ (shown in FIG. 2) shall be described later. The processing carried out by the function Yᵢ is as follows:
Applying a respective bijective operation Hᵢ for this round Rᵢ to a first input, namely the first amount of data a_{i,1}. The output that results from applying this bijective operation Hᵢ to the first amount of data a_{i,1} is the first result b_{i,1}, i.e. b_{i,1}=Hᵢ(a_{i,1}).
Processing the second amount of data a_{i,2}. The output that results from this processing is the second result b_{i,2}. This processing involves applying a plurality of processing operations K_{i,1}, . . . , K_{i,Nk}_{ᵢ}. Here, Nkᵢ is the number of processing operations in this plurality of processing operations for this round Rᵢ (and is, therefore an integer greater than 1). The plurality of processing operations K_{i,1}, . . . , K_{i,Nk}_{ᵢ} are applied sequentially (i.e. the first processing operation K_{i,1} acts on the second amount of data a_{i,2}, and each subsequent processing operation K_{i,j} (j=2, . . . , NKᵢ) acts on the result of the preceding processing operation). In particular, b_{i,2}=K_{i,Nk}_{ᵢ} (K_{i,Nk}_{ᵢ}₋₁ ( . . . (K_{i,2}(K_{i,1}(a_{i,2}))) . . . )). At least one of the processing operations is the same as the bijective operation Hᵢ that is applied to the first amount of data a_{i,1}, i.e. K_{i,j}=Hᵢ for at least one integer jε{1,2, . . . Nkᵢ}. This is shown in FIG. 4 by the arrows 400, 402.

As shall be described in more detail below, one or both of properties (A) and (B) below apply:

Property (A): For each of one or more of the processing operations K_{i,1}, . . . , K_{i,Nk}_{ᵢ}, that processing operation comprises functionality that is dependent on a respective part of the first result b_{i,1}. This is shown in FIG. 4 by an arrow 404. In other words, for at least one integer jε{1,2, . . . Nkᵢ}, the functionality provided by the processing operation K_{i,j} (i.e. the actual working of the processing operation K_{i,j}) is dependent on (at least part of) b_{i,1}. Thus, the first result b_{i,1} (or at least a part of the first result b_{i,1}) may be viewed as forming a parameter or setting that configures the processing operation K_{i,j}, so that the processing operation K_{i,j} will process its input based on this configuration parameter. This configuration parameter may, therefore, be a t_{i,j}-bit value, where each of the t_{i,j} bits is a bit taken from a respective location of the first result b_{i,1}—here, t_{i,j} is a positive integer corresponding to the round Rᵢ and to this particular processing operation K_{i,j}, and may vary from round to round or may be a predetermined value constant across all rounds. The particular bits (and the possibly the number of bits) of the result b_{i,1} that is/are used to configure the processing operation K_{i,j} may be selected based on at least part of the cryptographic key ψ of the method 100. Conversely, the choice of which particular bits (and possibly how many bits) of the result b_{i,1} that is/are used to configure the processing operation K_{i,1} may be viewed as defining or specifying at least part of the cryptographic key ψ. For example, the choice of which bits (and possibly how many bits) to use from the result b_{i,j} may be randomly selected using a random number generator seeded by at least part of the cryptographic key ψ. Examples of such processing operations K_{i,j} shall be given later.

Property (B): For each of one or more of the processing operations K_{i,1}, . . . , K_{i,Nk}_{ᵢ}, a number of times (referred to herein as the number β) that processing operation is applied is dependent on a respective part of the first result b_{i,1}. In other words, the make-up of the sequence of processing operations K_{i,1}, . . . , K_{i,Nk}_{ᵢ} is dependent on the first result b_{i,1} (or at least on a part of the first result b_{i,1}). This is shown in FIG. 4 by the arrow 404. Therefore, for at least one integer jε{1,2, . . . Nkᵢ}, the number of times β_{i,j} that the processing operation K_{i,j} occurs in the sequence of processing operations K_{i,1}, . . . , K_{iNk}_{ᵢ} (i.e. the number of integers αε{1,2, . . . Nkᵢ} where K_{i,j}=K_{i,α}) is dependent on the first result b_{i,1} (or on at least a part of the first result b_{i,1}). Thus, the number Nkᵢ is itself dependent on the first result b_{i,1} (or on at least a part of the first result b_{i,1}). These instances/performances of the same processing operation K_{i,1} may be consecutive in the sequence of processing operations K_{i,1}, . . . , K_{i,Nk}_{ᵢ}, i.e. a number β_{i,j} may be determined based on at least a part of the first result b_{i,1} so that, in the sequence of processing operations K_{i,1}, . . . , K_{i,Nk}_{ᵢ}, the processing operations K_{i,j}, K_{i,j+1}, . . . , K_{i,j+β}_{_{i,j}}₋₁ are all the same. However, it will be appreciated that this need not be the case and that the β_{i,j} instances of the processing operation K_{i,j} may be dispersed amongst other processing operations within the sequence of processing operations K_{i,1}, . . . , K_{i,Nk}_{ᵢ}. Thus, the first result b_{i,1} (or at least a part of the first result b_{i,1}) may be viewed as forming a configuration parameter or setting that specifies how many additional times a particular processing operation K_{i,j} is repeated (or performed again). This configuration parameter may, therefore, be an s_{i,j}-bit value, where each of the s_{i,j} bits is a bit taken from a respective location of the first result b_{i,1}—here, s_{i,j} is a positive integer corresponding to the round Rᵢ and to this particular processing operation K_{i,j}, and may vary from round to round or may be a predetermined value constant across all rounds. The particular bits (and the possibly the number of bits) of the result b_{i,1} that is/are used to define the number of repeated performances of the processing operation K_{i,j} may be selected based on at least part of the cryptographic key ψ of the method 100. Conversely, the choice of which particular bits (and possibly how many bits) of the result b_{i,1} that is/are used for this configuration parameter may be viewed as defining or specifying at least part of the cryptographic key ψ. For example, the choice of which bits (and possibly how many bits) to use from the result b_{i,1} may be randomly selected using a random number generator seeded by at least part of the cryptographic key ψ.

By having property (A) and/or (B) discussed above, the function Yᵢ (and hence the round function Rᵢ and the method 100) is significantly more difficult for an attacker to reverse engineer or analyse, since the actual algorithm or steps carried out by the method 100 is dynamically changed/updated during the performance of the method 100 in a manner that is ultimately dependent on the input data d₁ being processed, i.e. the nature of the method 100 varies based on the input data d₁ and the intermediate results generated whilst carrying out the method 100.

The input amounts of data a_{i,1} and a_{i,2} are preferably of the same bit-size. The input amounts of data a_{i,1} and a_{i,2} comprise bits taken from the input data dyᵢ for the function Yᵢ. In some embodiments, the input amounts of data a_{i,1} and a_{i,2} are non-overlapping portions of the input data dyᵢ; in other embodiments, the input amounts of data a_{i,1} and a_{i,2} are overlapping portions of the input data dyᵢ. However, in preferred embodiments, if the input data dyᵢ comprises 2λ number of bits, then the input amounts of data a_{i,1} and a_{i,2} are non-overlapping portions of the input data dyᵢ each with λ number of bits. The choice of which bits of the input data dyᵢ contribute to which input amount of data a_{i,1} and a_{i,2} may be set based on, or may define or specify, at least part of the cryptographic key ψ for the method 100.

The results b_{i,1} and b_{i,2} are preferably of the same bit-size. The output data eyᵢ for the function Yᵢ is formed from the results b_{i,1} and b_{i,2}. In some embodiments, each bit of the output data eyᵢ is based on one or more bits of the first result b_{i,1} and/or the second result b_{i,2}. In preferred embodiments, each bit of the output data eyᵢ is set to be a corresponding bit from either the first result b_{i,1} or the second result b_{i,2}. The choice of how to map the bits of the results b_{i,1} and b_{i,2} to bits of the output data eyᵢ may be set based on, or may define or specify, at least part of the cryptographic key ψ for the method 100.

Preferably, the output data eyᵢ and the input data dyᵢ are of the same bit-size.

Thus, the output data eᵢ for the round Rᵢ is based on the first and second results b_{i,1} and b_{i,2}. Similarly, the amounts of data a_{i,1} and a_{i,2} are based on the input data dᵢ for the round Rᵢ. For embodiments of the invention in which the round function Rᵢ (i=1, . . . , Nr) comprises the function Xᵢ as shown in FIG. 3, it is clear that the first amount of data a_{i,1} and the second amount of data a_{i,2} are based on the output chunk of data gᵢ generated by the function Xᵢ.

FIG. 5 schematically illustrates the bijective operation (or function or mapping) Hᵢ for the round Rᵢ according to an embodiment of the invention (for i=1, . . . , Nr). As shall become apparent from the discussion below, the bijective operation Hᵢ corresponds to, or may define or specify, at least part of the cryptographic key ψ for the method 100.

The bijective operation is arranged to bijectively map an input value uᵢ to an output value vᵢ. Both the input value uᵢ and the output value vᵢ comprise a number nᵢ of bits, where nᵢ is a positive integer corresponding to the round Rᵢ. This is shown in FIG. 5 with the input value uᵢ comprising bits u_{i,1}, . . . , u_{i,n}_{ᵢ} and the output value vᵢ comprising bits v_{i,1}, . . . , v_{i,n}_{ᵢ}.

It will be appreciated that the bijection provided by the function Hᵢ may be implemented in any way, since all that is required is that the function Hᵢ maps the domain of values with nᵢ bits in a 1-to-1 manner to corresponding values with nᵢ bits. This could, for example, be a random mapping (determined by a random number generator seeded by at least part of the cryptographic key ψ for the method 100). However, the architecture/structure shown in FIG. 5 for implementing the function Hᵢ is preferable as it (a) makes efficient use of hardware components (namely the individual bijective mappings B_{i,j,k}); (b) makes it easier to form the bijective operation Hᵢ based on the cryptographic key ψ for the method 100 (or, conversely, to determine or specify at least a part of the cryptographic key ψ for the method 100 based on the structure that has been used for the bijective operation Hᵢ); and (c) helps improve cryptographic strength by ensuring that bits of the input value uᵢ can affect a large number (and preferably all) of bits of the output value vᵢ. Thus, the structure shown in FIG. 5 for the function Hᵢ helps improve the cryptographic strength of the method 100 whilst also helping to make it easier to make multiple different instances (i.e. make particular versions or diversified implementations) of the method 100.

As shown in FIG. 5, the implementation of the bijective operation Hᵢ for the round Rᵢ (i=1, . . . , Nr) may comprise using a sequence of Nsᵢ sets S_{i,j} (j=1, . . . , Nsᵢ) of bijective mappings (or functions or operations). Here Nsᵢ is a positive integer corresponding to the round Rᵢ. Each set S_{i,j} (j=1, . . . , Ns) has a respective number Nb_{i,j} of respective bijective mappings B_{i,j,1}, . . . , B_{i,j,Nb}_{_{i,j}}, wherein each bijective mapping B_{i,j,k} (k=1, . . . , Nb_{i,j}) is arranged to bijectively map an input value with a respective number w_{i,j,k} of bits to an output value with w_{i,j,k} bits, wherein for j=1, . . . , Nsᵢ, Σₖ₌₁^{Nb}^{^{i,j}}w_{i,j,k}=nᵢ. In particular:
For the first set S_{i,1}, the input value for the bijective mapping B_{i,l,k} (k=1, . . . , Nb_{i,1}) is formed from w_{i,1,k} respective bits from the nᵢ-bit input value uᵢ selected according to at least part of the cryptographic key ψ. For example, each bit of the input value uᵢ may be a corresponding bit of an input for just one of the bijective mappings B_{i,l,k}, where this correspondence (shown as connecting lines 500 in FIG. 5) of bits from the input value uᵢ to bits of the inputs to the bijective mappings B_{i,1,k} is dependent on at least part of the cryptographic key ψ of the method 100. Conversely, this correspondence 500 may be viewed as defining at least part of the cryptographic key p. The correspondence 500 may be randomly selected using a random number generator seeded by at least part of the cryptographic key ψ.
For the subsequent sets set S_{i,j} (j=2, . . . , Nsᵢ), the input value for the bijective mapping B_{i,j,k} (k=1, . . . , Nb_{i,j}) comprises w_{i,j,k} bits from the output values of the preceding set S_{i,j-1} of bijective mappings B_{i,j-1,1}, . . . B_{i,j-1,Nb}_{_{i,j−1}}. Each bit of the outputs of the bijective mappings B_{i,j-1,k} (k=1, . . . , Nb_{i,j-1}) of the previous set S_{i,j-1} may be a corresponding bit of an input value for just one of the bijective mappings B_{i,j,k} of the current set of S_{i,j} of bijective mappings—this correspondence of bits is shown (at least between the sets S_{i,1} and S_{i,2}) as connecting lines 502 in FIG. 5. The correspondence 502 may vary from one pair of adjacent sets to another pair of adjacent sets. This correspondence 502 may be predetermined. Conversely, this correspondence may be dependent on (or be viewed as defining) at least part of the cryptographic key ψ of the method 100, in the same manner as for the correspondence 500.
The nᵢ-bit output value vᵢ comprises the bits from the output values of the bijective mappings B_{i,Ns}_{_{i,}}₁, . . . , B_{i,Ns}_{_{i,}}_{Nb}_{_{i,Nsi}} of the final set S_{i,Ns}_{ᵢ}, arranged based on at least part of the cryptographic key ψ for the method 100. For example, each bit of each output value from each of the bijective mappings B_{i,Ns}_{_{i,}}₁, . . . , B_{i,Ns}_{_{i,}}_{Nb}_{_{i,Nsi}} may be used as a corresponding bit at a corresponding location in the output value vᵢ, where this correspondence (shown as connecting lines 504 in FIG. 5) of bits from the output of the bijective mappings B_{i,Ns}_{_{i,}}₁, . . . , B_{i,Ns}_{_{i,}}_{Nb}_{_{i,Nsi}} to the bits of the output value vᵢ is dependent on at least part of the cryptographic key ψ of the method 100. Conversely, this correspondence 504 may be viewed as defining or specifying at least part of the cryptographic key ψ. For example, the correspondence 504 may be randomly selected using a random number generator seeded by at least part of the cryptographic key ψ.

For each bijective mappings B_{i,j,1}, . . . B_{i,j,Nb}_{_{i,j}} (i=1, . . . , Nr, j=1, . . . , Nsᵢ) the actual respective bijection performed by that bijective mapping may be randomly selected using a random number generator seeded by at least part of the cryptographic key ψ. Conversely, the respective bijections performed by these bijective mappings may be viewed as defining or specifying at least part of the cryptographic key q. For example, each bijective mapping B_{i,j,k} (i=1, . . . , Nr, j=1, . . . , Nsᵢ, k=1, . . . , Nb_{i,j}) may be a respective randomly generated bijection of the set of numbers {0, 1, 2, . . . , 2^{w}^{^{i,j,k}}-1}.

Referring back to FIG. 4, when the function Hᵢ is being used to process the input amount of data a_{i,1}, the input value uᵢ is the input amount of data a_{i,1} and the output value vᵢ is the output amount of data b_{i,1}. Similarly, when the function Hᵢ is one of the processing operations K_{i,j}, then the input value uᵢ is the input to the processing operation K_{i,j} (as represented by the arrow 400) and the output value vᵢ is the output from the processing operation K_{i,j} (as represented by the arrow 402).

In preferred embodiments, the sequence of Nsᵢ sets S_{i,j} (j=1, . . . , Nsᵢ) of bijective mappings is arranged so that each bit u_{i,j} of the nᵢ-bit input value uᵢ affects all (or substantially all) of the bits v_{i,j} of the nᵢ-bit output value vᵢ. This helps improve cryptographic security of the bijective operation Hᵢ and, therefore, of the method 100. One way of achieving this is by having the Nsᵢ sets S_{i,j} (j=1, . . . , Nsᵢ) of bijective mappings form a Banyan network. Banyan networks are well-known and shall, therefore, not be described in more detail herein.

As can be seen from the above, the method 100 can be configured in a number of different ways, which can be viewed as setting or defining (or at least corresponding to) a cryptographic key ψ. Conversely, given a cryptographic key ψ (which could be randomly generated) the configuration of the method 100 may be determined/set accordingly (e.g. by using the cryptographic key ψ as a seed for a random number generator, and using random numbers generated by that seeded random number generator to specify the configuration). In particular, the cryptographic key ψ may correspond to, or define, one or more of the following parameters/settings:
The number Nbᵢ of bijective mappings B_{i,j} used for the function Xᵢ for the corresponding round Rᵢ (i=1, . . . , Nr).
The actual bijection carried out by the bijective mapping B_{i,j} for the function Xᵢ (i=1, . . . , Nr and j=1, . . . , Nbᵢ). The number of bits operated on by the bijective mapping B_{i,j} is w_{i,j}, so that there are (2^{w}^{^{i,j}})! possible bijections that could be chosen for, or implemented by, the bijective mapping B_{i,j}.
The bit width w_{i,j} of the input and output of the bijective mapping B_{i,j} for the function Xᵢ (i=1, . . . , Nr and j=1, . . . , Nbᵢ).
The number Nsᵢ of sets of bijective mappings B_{i,j,k} used for the function Yᵢ for the corresponding round Rᵢ (i=1, . . . , Nr).
The number Nb_{i,j} of bijective mappings B_{i,j,k} for the set Sⱼ (i=1, . . . , Nr and j=1, . . . , Nsᵢ).
The actual bijection carried out by the bijective mapping B_{i,j,k} for the function Hᵢ (i=1, . . . , Nr, j=1, . . . , Nsᵢ, k=1, . . . , Nb_{i,j}). The number of bits operated on by the bijective mapping B_{i,j,k} is w_{i,j,k}, so that there are (2^{w}^{^{i,j,k}})! possible bijections that could be chosen for, or implemented by, the bijective mapping B_{i,j,k}.
The bit width w_{i,j,k} of the input and output of the bijective mapping B_{i,j,k} (i=1, . . . , Nr, j=1, . . . , Nsᵢ, k=1, . . . , Nb_{i,j}).
The ways in which one or more of the correspondences 300, 302, 500, 502, 504 are set up. For example, for the i^{th} round Rᵢ, for each correspondence 300, 302 there are (2^{m}^{ⁱ})! possible correspondences; similarly, with each correspondence 500, 502, 504 there are (2ⁿ^{ⁱ})! possible correspondences.
For properties (A) and (B) discussed above, the bits (and possible the number of bits) of the first result b_{i,1} used in relation to those properties (A) and (B).

Whilst the size of the key space for the cryptographic key ψ is not simply the product of the above-mentioned numbers of possible bijections and numbers of possible correspondences and possible bit-choices for properties (A) and (B) (because some combinations of these will be equivalent to other combinations), the structure for the method 100 described above still provides an extremely large size of the key space in an easily achieved/configurable way (i.e. the bit-size of the equivalent cryptographic key can be made very large indeed whilst still providing great flexibility for producing individualized instances/implementations of the method 100 with corresponding different keys).

Thus, the method 100 as described above provides a number of advantages:

(a) An extremely large size of the key space.

(b) It is easy to configure the method 100 according to a particular key. The bit-size of the equivalent cryptographic key can be made very large indeed whilst still providing great flexibility for producing individualized instances/implementations of the method 100 with corresponding different keys.

(c) Properties (A) and (B) mean that it is significantly more difficult for an attacker to reverse engineer or analyse any particular implementation/instance of the method 100, since the actual algorithm or steps carried out by the method 100 is dynamically changed/updated during the performance of the method 100 in a manner that is ultimately dependent on the input data d₁ being processed, i.e. the nature of the method 100 varies based on the input data d₁ and the intermediate results generated whilst carrying out the method 100.

(d) An implementation of the method can be made to use a relatively small amount of hardware or software resources e.g. due to the re-use of the function Hᵢ during a round Rᵢ (for i=1, . . . , Nr); and due to property (B).

(e) The actual algorithm provides cipherlike levels of security.

### 2—Specific Example Embodiment

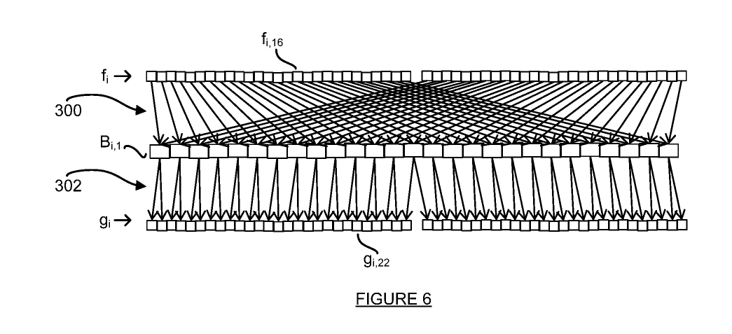

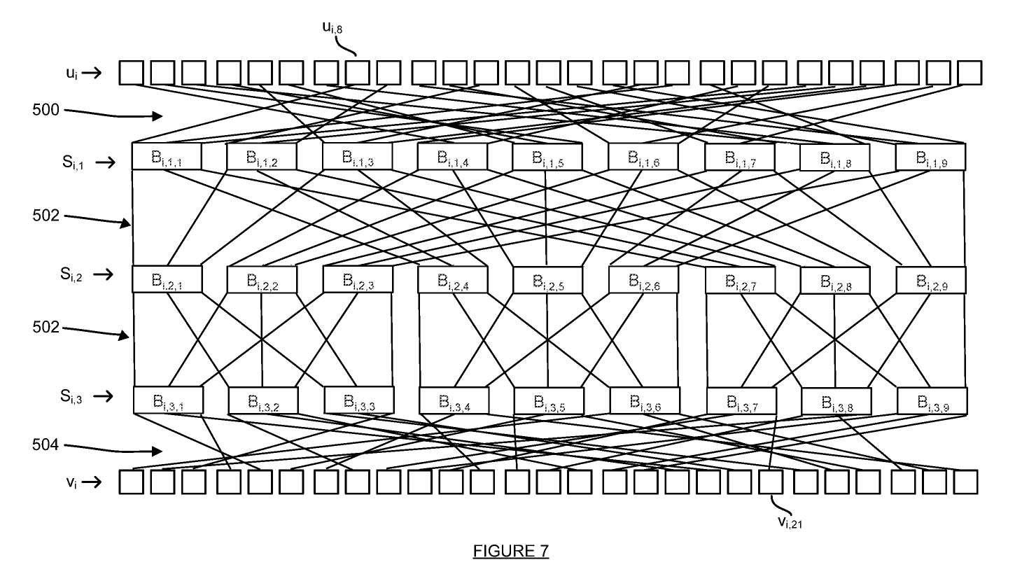

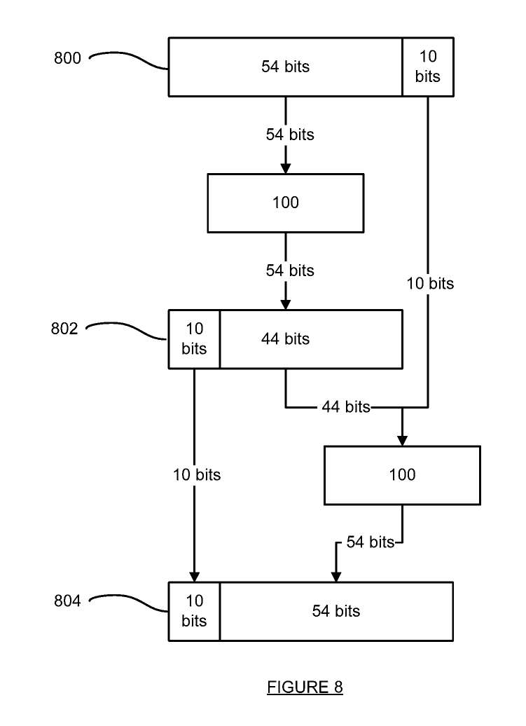

A particular example of the method 100 is illustrated schematically in FIGS. 6-7 as described below.

In this example embodiment: the function Xᵢ is included in each round function Fᵢ (i=1, . . . , Nr); the pre-processing step 200 is not included in the round functions Fᵢ (i=1, . . . , Nr); the intermediate-processing step 202 is not included in the round functions Fᵢ (i=1, . . . , Nr); the post-processing step 204 is not included in the round functions Fᵢ (i=1, . . . , Nr−1); and the post-processing step 204 is included in the round function F_{Nr}—here the post-processing step simply comprises performing the function X_{Nr+1} (i.e. the basic function Xᵢ but potentially configured differently from the earlier instances of that function, namely X₁, . . . , X_{Nr}).

In this example embodiment, the number of rounds Nr is 5, although it will be appreciated that this could be set to any other positive integer. The larger the number, the greater the cryptographic security or, at the very least, the more difficult it would be for an attacker to successfully attack/analyse the method 100; conversely, the smaller the number, the less time it will take to process the input data d₁ (i.e. process speed or latency is reduced) and the less memory and/or hardware resources required. The value Nr=5 is considered to be a good value that balances these issues.

In this example embodiment, the size of each input data dᵢ and each output data e; (i=1, . . . , Nr) is 54 bits.

FIG. 6 schematically illustrates the function Xᵢ, which is similar to that shown in FIG. 3 but with specific configuration for this particular embodiment. The input to the function Xᵢ (i.e. dxᵢ=fᵢ) and the output from the function Xᵢ (i.e. exᵢ=gᵢ) are both 54 bit data blocks. For ease of illustration, only one bit of the input fᵢ is labeled (namely bit 16: f_{i,16}), only one bit of the output gᵢ is labeled (namely bit 22: g_{i,22}), and only one bijective mapping is labeled (namely B_{i,1}). As can be seen:
For each round Rᵢ (i=1, . . . , Nr), the corresponding number Nbᵢ of bijective mappings B_{i,j} for the function Xᵢ is 27. For each of the bijective mappings B_{i,j} (i=1, . . . , Nr, j=1, . . . , 27), the corresponding value of w_{i,j} is w_{i,j}=2, i.e. each bijective mappings B_{i,j} (j=1, . . . , Nbᵢ) is a bijection mapping a 2-bit number to a 2-bit number. There are, therefore, (2²)!=24 possible choices for each of the 27 bijective mappings B_{i,j} (j=1, . . . , 27) for each of the rounds Rᵢ (i=1, . . . , Nr). Each of these bijective mappings B_{i,j} (i=1, . . . , Nr, j=1, . . . , 27) may be set based on (or conversely may define or specify) at least a part of the cryptographic key ψ.
The correspondence 300 takes a bit from a first half (the left half shown in FIG. 6) of the input fᵢ and a bit from the other half (the right half shown in FIG. 6) of the input fᵢ to form a 2-bit input for each bijective mapping B_{i,j}. The particular correspondence 300 shown in FIG. 6 is arranged so that the 2-bit input to the bijective mapping B_{i,j} has bit-2 set to f_{i,j+27} and bit-1 set to f_{i,j} (i=1, . . . , Nr, j=1, . . . , 27). This could, of course, be the other way around. Again, this is purely an example, and other correspondences 300 could be used.
For each bijective mapping B_{i,j}, the correspondence 302 sets a corresponding bit from a first half (the left half shown in FIG. 6) of the output gᵢ to be one of the bits of the 2-bit output of B_{i,j} and sets a corresponding bit from the other half (the right half shown in FIG. 6) of the output gᵢ to be the other bit of the 2-bit output of B_{i,j}. The particular correspondence 302 shown in FIG. 6 is arranged so that, for j=1, . . . , 27, the (2j−1)^{th} bit of the output gᵢ, i.e. bit g_{i,2j-1} is bit-1 of the output of B_{i,j} whilst the (2j)^{th} bit of the output gᵢ, i.e. bit g_{i,2j} is bit-2 of the output of B_{i,j}. This could, of course, be the other way around. Again, this is purely an example, and other correspondences 302 could be used.

We turn next to the function Yᵢ for this particular embodiment.

As the output of the function Xᵢ is a 54-bit block of data exᵢ, the input to the function Yᵢ (namely dyᵢ=exᵢ) is also a 54-bit block of data. Similarly, the output eyᵢ of the function Yᵢ is a 54-bit block of data.

The first and second amounts of data a_{i,1} and a_{i,2} are both 27-bits respective bits from the input dyᵢ to the function Yᵢ. This may simply be that a_{i,1} comprises the most (or least) significant 27 bits of dyᵢ (in the same order as in dyᵢ), and that a_{i,2} comprises the least (or most) significant 27 bits of dyᵢ (in the same order as in dyᵢ). However, the partitioning of dyᵢ into two separate blocks of 27-bits, namely into a_{i,1} and a_{i,2} could be done in any other way (with a_{i,1} and a_{i,2} potentially interleaved to form dyᵢ).

The specific version of the bijective operation Hᵢ shall be described shortly with reference to FIG. 7. In any case, as set out above, the first result b_{i,1} is formed as b_{i,1}=Hᵢ(a_{i,1}). Thus, b_{i,1} is a 27-bit amount of data.

For processing the second amount of data a_{i,2}, the following sequence of processing operations is performed:
The first processing operation K_{i,1} cyclically rotates the bits of its input (which is a_{i,2} in this case). This could be a left rotation or a right rotation. The number of places/bits by which K_{i,1} cyclically rotates the bits of its input is dependent on (or set by) a configuration parameter pal whose value is made from corresponding bits of the first result b_{i,1}. In this embodiment, pal is a 2-bit value, i.e. two bits of b_{i,1} (at a corresponding predetermined location within b_{i,1}) are used to define the number of places/bits by which K_{i,1} cyclically rotates the bits of its input. In this particular embodiment, the number of places/bit by which K_{i,1} cyclically rotates the bits of its input is paᵢ+1 bits, so that the rotation could, therefore, be by 1, 2, 3 or 4 positions/bits. The output of K_{i,1} is therefore also a 27-bit amount of data. K_{i,1} is one of the processing operations for property (A) described above.
The second processing operation K_{i,2} flips or inverts a number of bits of its input (which is the output of K_{i,1}). The number of bits of the input to K_{i,2} that K_{i,2} flips is dependent on (or set by) a configuration parameter pbᵢ whose value is made from corresponding bits of the first result b_{i,1}. In this embodiment, pbᵢ is a 2-bit value, i.e. two bits of b_{i,1} (at a corresponding predetermined location within b_{i,1}) are used to define the number of bits of the input to K_{i,2} that K_{i,2} flips. In this particular embodiment, the number of bits flipped is pbᵢ+1 bits, so that the number of bits flipped could, therefore, be 1, 2, 3 or 4 bits. The location of those bits could be any predetermined locations. In this specific embodiment, the bits that are flipped are the pbᵢ least significant bits of the input to K_{i,2}. The output of K_{i,2} is therefore also a 27-bit amount of data. K_{i,2} is one of the processing operations for property (A) described above.
The third processing operation K_{i,3} is the bijective operation Hᵢ. Thus K_{i,3} involves applying the bijective operation Hᵢ to the output of the processing operation K_{i,2}. The processing operation K_{i,3} is one of the processing operations for property (B) described above. Thus, the number of times that the processing operation (Kᵢ,3=Hᵢ) is repeated is dependent on (or set by) a configuration parameter pcᵢ whose value is made from corresponding bits of the first result b_{i,1}. In this embodiment, pcᵢ is a 2-bit value, i.e. two bits of b_{i,1} (at a corresponding predetermined location within b_{i,1}) are used to define the extra times K_{i,3} is performed. Thus, K_{i,3} could be repeated 0, 1, 2 or 3 times. Thus, in the sequence of processing operations K_{i,1}, the processing operations K_{i,3}, . . . , K_{i,3+pc}_{ᵢ} are all the same (namely Hᵢ).
The next processing operation performed, namely K_{i,4+pc}_{ᵢ}, flips or inverts a number of bits of its input (which is the output of K_{i,3+pc}_{ᵢ}). The number of bits of the input to K_{i,4+pc}_{ᵢ} that K_{i,4+pc}_{ᵢ} flips is dependent on (or set by) a configuration parameter pdᵢ whose value is made from corresponding bits of the first result b_{i,1}. In this embodiment, pdᵢ is a 2-bit value, i.e. two bits of b_{i,1} (at a corresponding predetermined location within b_{i,1}) are used to define the number of bits of the input to K_{i,4+pc}_{ᵢ} that K_{i,4+pc}_{ᵢ} flips. In this particular embodiment, the number of bits flipped is pdᵢ+1 bits, so that the number of bits flipped could, therefore, be 1, 2, 3 or 4 bits. The location of those bits could be any predetermined locations. In this specific embodiment, the bits that are flipped are the pdᵢ least significant bits of the input to K_{i,4+pc}_{ᵢ}. The output of K_{i,4+pc}_{ᵢ} is therefore also a 27-bit amount of data. K_{i,4+pc}_{ᵢ} is one of the processing operations for property (A) described above. Thus, the processing operation K_{i,4+pc}_{ᵢ} is the same as the processing operation K_{i,2}, except that it operates on different input data and may use different bits of b_{i,1} to set its configuration parameter.
The next processing operation performed, namely K_{i,5+pc}_{ᵢ}, cyclically rotates the bits of its input (which is the output of K_{i,4+pc}_{ᵢ}). This could be a left rotation or a right rotation. The number of places/bits by which K_{i,5+pc}_{ᵢ} cyclically rotates the bits of its input is dependent on (or set by) a configuration parameter peᵢ whose value is made from corresponding bits of the first result b_{i,1}. In this embodiment, peᵢ is a 2-bit value, i.e. two bits of b_{i,1} (at a corresponding predetermined location within b_{i,1}) are used to define the number of places/bits by which K_{i,5+pc}_{ᵢ} cyclically rotates the bits of its input. In this particular embodiment, the number of places/bit by which K_{i,5+pc}_{ᵢ}, cyclically rotates the bits of its input is peᵢ+1 bits, so that the rotation could, therefore, be by 1, 2, 3 or 4 positions/bits. The output of K_{i,5+pc}_{ᵢ} (namely the second result b_{i,2}) is therefore also a 27-bit amount of data. K_{i,5+pc}_{ᵢ} is one of the processing operations for property (A) described above. Thus, the processing operation K_{i,5+pc}_{ᵢ}, is the same as the processing operation K_{i,1}, except that it operates on different input data and may use different bits of b_{i,1} to set its configuration parameter.

Preferably, the configuration parameters paᵢ, pbᵢ, pcᵢ, pdᵢ and peᵢ for each round Rᵢ are set using respective different bits taken from the first result b_{i,1}. This helps increase the effective size of the key-space for the method 100. Similarly, in some embodiment, the choice of bits to use from the first result b_{i,1} changes from round to round.

The processing operations K_{i,1}, K_{i,2}, K_{i,4+pc}_{ᵢ} and K_{i,5+pc}_{ᵢ} are examples of processing operations that provide property (A) mentioned above. It will be appreciated that, in other embodiments of the invention, other types of processing may be carried out by processing operations K_{i,j} to provide property (A), such as: (i) adding a value to the input to K_{i,j} where the value is dependent on one or bits of b_{i,1}; (ii) reordering a certain number of bits of K_{i,j} backwards, where this number is dependent on one or more bits of b_{i,1}; etc.

FIG. 7 schematically illustrates the bijective operation Hᵢ, which is similar to that shown in FIG. 5 but with specific configuration for this particular embodiment. The input to the function Hᵢ (i.e. uᵢ) and the output from the function Hᵢ (i.e. vᵢ) are both 27 bit data blocks. For ease of illustration, only one bit of the input uᵢ is labeled (namely bit 8: u_{i,8}), only one bit of the output vᵢ is labeled (namely bit 21: v_{i,21}). As can be seen:
For each round Rᵢ (i=1, . . . , Nr), the corresponding number Nsᵢ of sets of bijective mappings B_{i,j,k} for the function Hᵢ is 3.
For each set S_{i,j} (i=1, . . . , Nr and j=1, . . . , 3), the number Nb_{i,j} of bijective mappings B_{i,j,k} in that set Sᵢ is 9.
For each set S_{i,j} (i=1, . . . , Nr and j=1, . . . , 3), for each bijective mapping B_{i,j,k} (k=1, . . . , 9) in that set the corresponding value of w_{i,j,k} is w_{i,j,k}=3, i.e. each bijective mappings B_{i,j,k} (k=1, . . . , Nb_{i,j}) is a bijection mapping a 3-bit number to a 3-bit number. There are, therefore, (2³)!=40320 possible choices for each of the 27 bijective mappings B_{i,j,k} (j=1, . . . , 3 and k=1, . . . , 9) for each of the rounds Rᵢ (i=1, . . . , Nr). Each of these bijective mappings B_{i,j,k} (i=1, . . . , Nr, j=1, . . . , 3 and k=1, . . . , 9) may be set by (or conversely may define or specify) at least a part of the cryptographic key ψ.
The correspondence 500 may be determined/set by (or conversely may define or specify) at least a part of the cryptographic key ψ. As shown in FIG. 7 (which shows just one example of the correspondence 500), the input for each bijective mapping B_{i,1,k} (k=1 . . . , 9) in the first set S_{i,1} is formed as a 3-bit input using three respective bits of the input uᵢ, where each bit of the input uᵢ forms just one input bit for the inputs of the bijective mappings B_{i,1,k} (k=1, . . . , 9).
The correspondence 502 between the first set S_{i,1} and the second set S_{i,2} is predetermined, and defined as follows:
   Let the 3-bit output of bijective mapping B_{i,1,k} (k=1, . . . , 9) comprise bits δ_{k,3}, δ_{k,2} and δ_{k,1} as a 3-bit value δ_{k,3}δ_{k,2}δ_{k,1}.
   Let the 3-bit input to bijective mapping B_{i,2,k} (k=1, . . . , 9) comprise bits φ_{k,3}, φ_{k,2} and φ_{k,1} as a 3-bit value φ_{k,3}φ_{k,2}φ_{k,1}.
   Then

$${ϕ}_{k , 3} = {δ}_{p , q} where p = 3 ( ( k - 1 ) mod 3 ) + 1 and q = 3 - ⌊ \frac{k - 1}{3} ⌋$$

$${ϕ}_{k , 2} = {δ}_{p , q} where p = 3 ( ( k - 1 ) mod 3 ) + 2 and q = 3 - ⌊ \frac{k - 1}{3} ⌋$$

$${ϕ}_{k , 1} = {δ}_{p , q} where p = 3 ( ( k - 1 ) mod 3 ) + 3 and q = 3 - ⌊ \frac{k - 1}{3} ⌋$$

The correspondence 502 between the second set S_{i,2} and third set S_{i,3} is predetermined, and defined as follows:
   Let the 3-bit output of bijective mapping B_{i,2,k} (k=1, . . . , 9) comprise bits δ_{k,3}, δ_{k,2} and δ_{k,1} as a 3-bit value δ_{k,3}δ_{k,2}δ_{k,1}.
   Let the 3-bit input to bijective mapping B_{i,3,k} (k=1, . . . , 9) comprise bits φ_{k,3}, φ_{k,2} and φ_{k,1} as a 3-bit value φ_{k,3}φ_{k,2}φ_{k,1}.
   Then

$${ϕ}_{k , 3} = {δ}_{p , q} where p = 3 \times ⌊ \frac{k - 1}{3} ⌋ + 1 and q = 3 - ( ( k - 1 ) mod 3 )$$

$${ϕ}_{k , 2} = {δ}_{p , q} where p = 3 \times ⌊ \frac{k - 1}{3} ⌋ + 2 and q = 3 - ( ( k - 1 ) mod 3 )$$

$${ϕ}_{k , 1} = {δ}_{p , q} where p = 3 \times ⌊ \frac{k - 1}{3} ⌋ + 3 and q = 3 - ( ( k - 1 ) mod 3 )$$

The correspondence 504 may be determined/set by (or conversely may define or specify) at least a part of the cryptographic key ψ. As shown in FIG. 7 (which shows just one example of the correspondence 504), the outputs form the bijective mapping B_{i,3,k} (k=1, . . . , 9) in the final set S_{i,3} each provide 3 bits for the output vᵢ, so that each bit of the output vᵢ corresponds to a respective bit of the output from one of the bijective mappings B_{i,3,k} (k=1, . . . 9).

It is worthy of note that:
Having w_{i,j,k}>2 (i=1, . . . , Nr, j=1, . . . , Nsᵢ, k=1, . . . , Nb_{i,j}) means that the corresponding bijective mapping B_{i,j,k} may be non-linear (or non-affine). Thus, in preferred embodiments (e.g. as shown in FIG. 7), at least some (and preferably all) of the bijective mappings B_{i,j,k} have w_{i,j,k}>2. The selection of the bijective mappings B_{i,j,k} may be carried out to ensure that they are always non-linear.
As described above for FIG. 7, preferably w_{i,j,k=}3 (i=1, . . . , Nr, j=1, . . . , Nsᵢ, k=1, . . . , Nb_{i,j}). This is the smallest value for which the corresponding bijective mappings B_{i,j,k} may be non-linear (or non-affine). By using w_{i,j,k}=3, the hardware or software resources needed to implement all of the bijective mapping B_{i,j,k} is substantially smaller than would be required for a higher value of w_{i,j,k}. Thus, by having w_{i,j,k}=3 (i=1, . . . , Nr, j=1, . . . , Nsᵢ, k=1, . . . , Nb_{i,j}), the smallest hardware or software resource usage is achieved subject to being able to have non-linear bijections.
Having correspondences 502 as shown in FIG. 7 means that, for each round Rᵢ (i=1, . . . , Nr), the bijective mappings B_{i,j,k} (j=1, . . . , Nsᵢ, k=1, . . . , Nb_{i,j}) form a Banyan network. This provides an efficient way (from a hardware or software resources perspective) of ensuring that every bit u_{i,j} of the input uᵢ to the bijective function Hᵢ can affect (or contribute towards) the value assumed by every output bit v_{i,j} of the output vᵢ. This helps increase the overall security of the method 100. Whilst it would be possible to ensure that every bit u_{i,1} of the input uᵢ to the bijective function Hᵢ can affect the value assumed by every output bit v_{i,j} of the output vᵢ using other correspondences 502, as mentioned, the particular ones used in FIG. 7 are beneficial from a small hardware/software resource usage perspective.

Indeed, it is the choice of having w_{i,j,k}=3 (i=1, . . . , Nr, j=1, . . . , Nsᵢ, k=1, . . . , Nb_{i,j}) together with the use of the Banyan network within the function Hᵢ (i=1, . . . , Nr) that determines: (a) the size of the input to the function Hᵢ is 27 bits, as can be seen from FIG. 7 and (b) therefore the size of the inputs dᵢ and outputs eᵢ (i=1, . . . , Nr) is 2×27=54 bits.

It will be appreciated that, whilst the size of the inputs d₁ and the output e_{Nr} of the method 100 in this particular example embodiment is 54 bits, this particular embodiment of the method 100 may be used to process amounts of data with a different number of bits, using any standard technique for adapting a block cipher to process data of different sizes. An example is shown schematically in FIG. 8, wherein the amount of data 800 to be processed comprises 64 bits. In this example, the method 100 is used to process 54 bits of the input 64 bit quantity of data 800 to produce an intermediate result 802 with 54 bits. The method 100 is then used to process a 54 bit amount of data comprising (a) 44 bits from the intermediate result 802 and the 10 bits from the initial amount of data 800 that were not processed to produce the intermediate result 802. The final output amount of data 804 is then a 64 bit quantity of data that comprises (a) the 54 bits produced by this second application of the method 100 and (b) the 10 bits of the intermediate result 802 that were not processed by the second application of the method 100. It will be appreciated that there are numerous variations of FIG. 8 that could be implemented in order to be able to process an input amount of data of arbitrary data size, and that this may make use of other versions of the method 100 other than the specific example embodiment discussed above.

### 3—System Overview

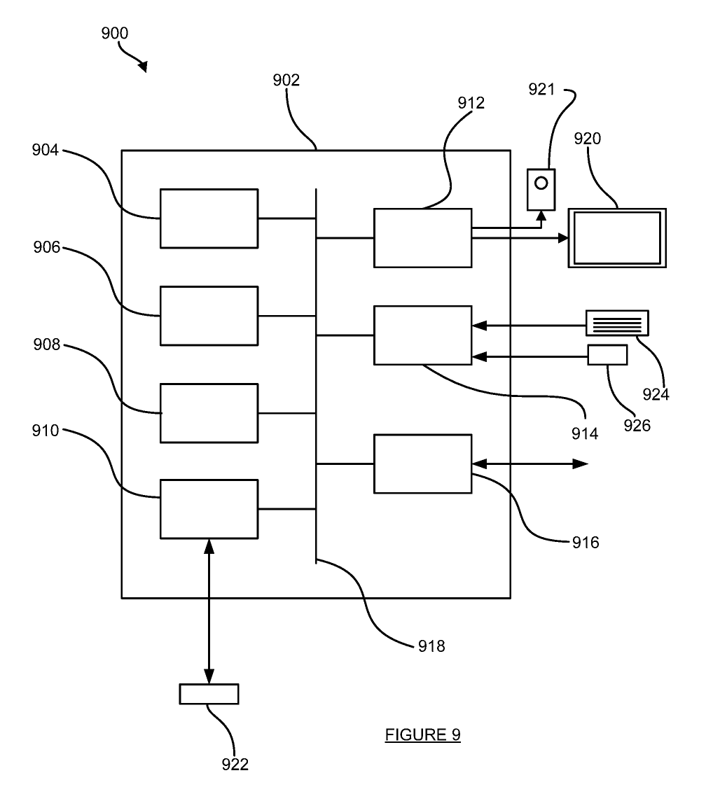

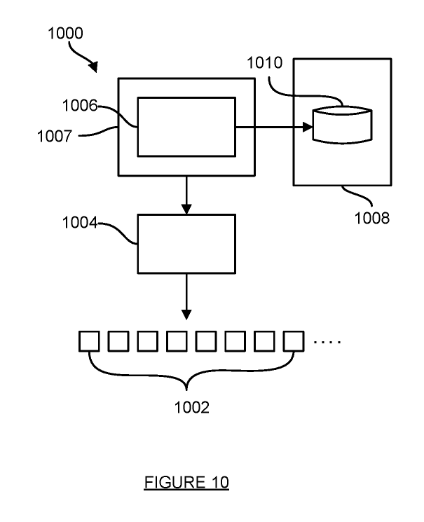

FIG. 9 schematically illustrates an example of a computer system 900. The system 900 comprises a computer 902. The computer 902 comprises: a storage medium 904, a memory 906, a processor 908, an interface 910, a user output interface 912, a user input interface 914 and a network interface 916, which are all linked together over one or more communication buses 918.

The storage medium 904 may be any form of non-volatile data storage device such as one or more of a hard disk drive, a magnetic disc, an optical disc, a ROM, etc. The storage medium 904 may store an operating system for the processor 908 to execute in order for the computer 902 to function. The storage medium 904 may also store one or more computer programs (or software or instructions or code).

The memory 906 may be any random access memory (storage unit or volatile storage medium) suitable for storing data and/or computer programs (or software or instructions or code).

The processor 908 may be any data processing unit suitable for executing one or more computer programs (such as those stored on the storage medium 904 and/or in the memory 906), some of which may be computer programs according to embodiments of the invention or computer programs that, when executed by the processor 908, cause the processor 908 to carry out the method 100 according to an embodiment of the invention and configure the system 900 to be a system according to an embodiment of the invention. The processor 908 may comprise a single data processing unit or multiple data processing units operating in parallel, separately or in cooperation with each other. The processor 908, in carrying out data processing operations for embodiments of the invention, may store data to and/or read data from the storage medium 904 and/or the memory 906.

The interface 910 may be any unit for providing an interface to a device 922 external to, or removable from, the computer 902. The device 922 may be a data storage device, for example, one or more of an optical disc, a magnetic disc, a solid-state-storage device, etc. The device 922 may have processing capabilities—for example, the device may be a smart card. The interface 910 may therefore access data from, or provide data to, or interface with, the device 922 in accordance with one or more commands that it receives from the processor 908.

The user input interface 914 is arranged to receive input from a user, or operator, of the system 900. The user may provide this input via one or more input devices of the system 900, such as a mouse (or other pointing device) 926 and/or a keyboard 924, that are connected to, or in communication with, the user input interface 914. However, it will be appreciated that the user may provide input to the computer 902 via one or more additional or alternative input devices (such as a touch screen). The computer 902 may store the input received from the input devices via the user input interface 914 in the memory 906 for the processor 908 to subsequently access and process, or may pass it straight to the processor 908, so that the processor 908 can respond to the user input accordingly.

The user output interface 912 is arranged to provide a graphical/visual and/or audio output to a user, or operator, of the system 900. As such, the processor 908 may be arranged to instruct the user output interface 912 to form an image/video signal representing a desired graphical output, and to provide this signal to a monitor (or screen or display unit) 920 of the system 900 that is connected to the user output interface 912. Additionally or alternatively, the processor 908 may be arranged to instruct the user output interface 912 to form an audio signal representing a desired audio output, and to provide this signal to one or more speakers 921 of the system 900 that is connected to the user output interface 912.

Finally, the network interface 916 provides functionality for the computer 902 to download data from and/or upload data to one or more data communication networks.

It will be appreciated that the architecture of the system 900 illustrated in FIG. 9 and described above is merely exemplary and that other computer systems 900 with different architectures (for example with fewer components than shown in FIG. 9 or with additional and/or alternative components than shown in FIG. 9) may be used in embodiments of the invention. As examples, the computer system 900 could comprise one or more of: a personal computer; a server computer; a mobile telephone; a tablet; a laptop; a television set; a set top box; a games console; other mobile devices or consumer electronics devices; etc.

Whilst it will be appreciated that the general system 900 described above may be used to carry out, or implement, the method 100, it is clear from the above description of the method 100 (and particularly of the particular example embodiment discussed with reference to FIGS. 6 and 7) that the method 100 may be implemented in a manner that uses only a small amount of hardware (i.e. a small gate-count), this being due to its overall structure and the potential reuse of hardware components at different stages during the method 100. Moreover, as has been described, the method 100 is highly individualisable (according to the cryptographic key ψ for the method 100), so that it is easy to produce a large number of diversified/different instances of the method 100 whilst maintaining a high level of security. This means that the method 100 is particularly suited to being implemented in hardware via, for example, printed electronics or electron-beam lithography (or e-beam lithography) or other fabrication techniques that can be configured rapidly so as to produce different devices on each pass/print.

“Printed electronics” techniques are well-known methods and processes used to create or manufacture complete electrical devices or circuits on various substrates by a printing process or a printing technology. The printing may use many conventional printing technologies such as screen printing, flexography, gravure, offset lithography, inkjet and 3D printing techniques. In particular, electrically functional electronic or optical inks may be deposited on the substrate to thereby form active and/or passive electronic components. These components may include, for example, diodes, transistors, wires, contacts and resistors, as well as switches, sensors (such as light sensors), output devices, input devices, actuators, batteries, LEDs, etc. The device that results from the printed electronics process is referred to as a “printed electronics device” or a “printed electronics circuit”. As printed electronics is well-known, further detail shall not be provided herein. However, more information on printed electronics can be found at, for example, http://en.wikipedia.org/wiki/Printed_electronics, the entire contents of which are incorporated herein by reference. Naturally, the terms “printed electronics device” and “printed electronics circuit” are not to be confused with the term “printed circuit board” which is a board that supports electrical components (that actually provide the functionality) and connects those components using conductive tracks on the board.

Electron-beam lithography involves scanning a focused beam of electrons to draw custom shapes on a surface covered with an electron-sensitive film called a resist (a process referred to as “exposing”). The electron beam changes the solubility of the resist, enabling selective removal of either the exposed or non-exposed regions of the resist by immersing the resist in a solvent (a process referred to as “developing”). This enables creation of very small structures in the resist that can subsequently be transferred to the substrate material, often by etching. As electron-beam lithography is well-known, further detail shall not be provided herein. However, more information on electron-beam lithography can be found at, for example, http://en.wikipedia.org/wiki/Electron-beam_lithography, the entire contents of which are incorporated herein by reference. An example of creation of chips using electron beam lithography is by Mapper Lithography (see http://www.mapperlithography.com/).

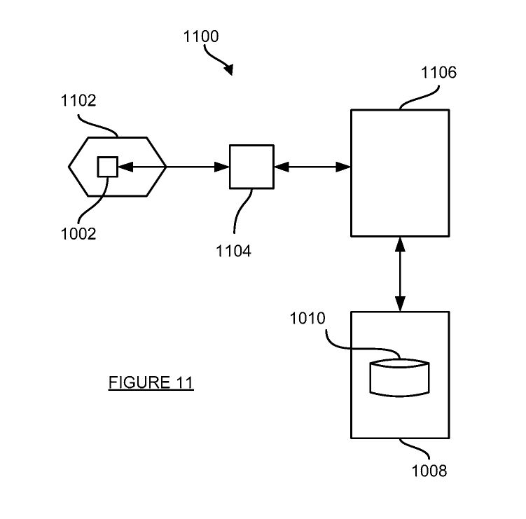

Such fabrication techniques enable the production of a series of hardware devices that each implement the method 100, with each device being configured differently from the other devices (using any of the above-mentioned options for configuration of the method 100 in line with the cryptographic key ψ for the method 100). This is illustrated schematically in FIG. 10.

FIG. 10 schematically illustrates a system 1000 for generating or manufacturing a plurality of devices (or chips) 1002.

The system 1000 comprises a device generator 1004 that is arranged to produce (or make or generate) the devices 1002 via one of the above-mentioned fabrication techniques. The device generator 1004 could, for example, be a printer that implements printed electronics printing, or could be an electron-beam lithography device for creating chips via electron-beam lithography. The device generator 1004 will, of course, need an input that specifies that nature (or makeup or configuration or layout or specification or arrangement of components) of each device 1002 that the device generator 1004 is to produce. The system 1000 therefore comprises a layout module 1007 that is arranged to produce a layout for each device and provide this layout (in a format suitable for use by the device generator 1004) to the device generator 1004. Such layout modules 1007 are well-known and shall not be described in more detail herein. The layout module 1007 may be implemented as, or executed on, any data processing system (such as one or more computer systems 900).

Each device 1002 is arranged to perform various functionality, including carrying out the method 100. Each device 1002 may be configured differently from the other devices 1002 that are produced. To this end, the layour module 1007 comprises a configuration module 1006. The configuration module 1006 is arranged to determine, for each device 1002, a corresponding configuration (as has been described above). This, the configuration module 1006 may be arranged to generate a key ψ for the method 100 specific to each device 1002 that is to be made and, based on that key ψ, determine a corresponding configuration for the method 100 that is to be implemented by the device 1002. Alternatively, the configuration module 1006 may be arranged to determine a configuration for the method 100 that is specific to each device 1002 that is to be made (e.g. by randomly generating a configuration), with this configuration then corresponding to (or setting/defining) a key ψ for the method 100 specific to that device 1002.

It will be appreciated that the devices 1002 may be arranged to perform other functionality in addition to carrying out the method 100, and may need additional components (such as data input/output interfaces, memory, etc.). The layout generated by the layer module 1007 comprises, or uses, the configuration for the method 100 that is generated by the configuration module 1006, together with details of other components/element that form the full layout for the device 1002.

The system 1000 may also comprise a configuration storage system 1008. The configuration storage system 1008 may be any data processing system and may, therefore, comprise one or more computer systems 900. For example, the configuration storage system 1008 may comprise one or more servers. The configuration storage system 1008 comprises a database 1010. The system 1000 may be arranged so that configurations generated by the configuration module 1006 are provided or communicated to the configuration storage system 1008—the configuration storage system 1008 may then store received configurations in the database 1010. This may involve storing just the keys ψ for the method 100 that defines the corresponding configurations, or may involve storing more detailed information about the configurations (e.g. details of the bijective mappings B_{i,j} and/or B_{i,j,k}, details of the correspondences 300, 302, 500, 502, 504, etc.). This means that an entity that has access to the database 1010 and the configurations stored therein may carry out the method 100 in a manner configured according to one or more of the stored configurations.

Each device 1002 may have a corresponding identifier (e.g. an identification number or character string). The identifier may uniquely identify the corresponding device 1002 and distinguish that device 1002 from all of the other devices 1002 that are made. This identifier may be generated by the layout module 1007 (and possibly the configuration module 1006); alternatively, the layout module 1007 may receive the identifier from an external source (not shown in FIG. 10). The layout generated by the layout module 1007 may be arranged so that the identifier of a device 1002 is stored as a value or as data within that device 1002. The device 1002 may be arranged to provide, or output, its identifier in response to receiving a request for its identifier. The device 1002 may be arranged to use its identifier as part of one or more operations (or data processing/functions) that the device 1002 is configured to perform. Additionally, the system 1000 may be arranged to provide the identifier for a device 1002 to the configuration storage system 1008 along with the configuration for that device 1002, so that the configuration storage system 1008 may then store received configurations in association with their respective identifiers in the database 1010. This means that, given an identifier for a particular device 1002, an entity that has access to the database 1010 and the configurations stored therein may determine, from the database 1010, the configuration corresponding to that identifier so that they can carry out the method 100 in a manner configured according that configuration (to thereby perform the method 100 in the same way in which that particular device 1002 should carry out its method 100, i.e. to mimic that specific device 1002).

### 4—Example Uses

The devices 1002 may be used in a variety of ways, examples of which are set out below. It will, of course, be appreciated that the devices 1002 may be put to other uses too, and embodiments of the invention are not to be viewed as limited to the examples below.

FIG. 11 schematically illustrates a system 1100 according to an embodiment of the invention.

The system 1100 may be used to provide an indication of whether or not an article/object 1102 is genuine (or authentic). The article 1102 may be any object (e.g. an item that a person may be considering buying or taking delivery of, and for which that person wishes to verify that that item is genuine and not a counterfeit). In the system 1100, an original (or genuine) article 1102 has affixed (or applied or attached) thereto, or embedded (or contained) within, a corresponding device 1002. The device 1002 may be attached to the article 1102 in any convenient manner, such as via an adhesive, being integrally formed with the article 1102, being attached via a locking mechanism (e.g. a security pin/tag), etc.

In order to be able to check the authenticity of the article 1102, the system 1100 comprises a verification device 1104 and a verification system 1106. The verification system 1106 may be arranged to communicate with the configuration storage system 1008 or, alternatively, the verification system 1106 may comprise the configuration storage system 1008.

The verification device 1104 and the verification system 1106 may be arranged to communicate with each other via any suitable data communication method. For example, the verification device 1104 and the verification system 1106 may communicate with each other via a network (not shown in FIG. 11). The network may be any kind of data communication network suitable for communicating or transferring data between the verification device 1104 and the verification system 1106. Thus, the network may comprise one or more of: a local area network, a wide area network, a metropolitan area network, the Internet, a wireless communication network, a wired or cable communication network, a satellite communications network, a telephone network, etc. The verification device 1104 and the verification system 1106 may be arranged to communicate with each other via the network via any suitable data communication protocol. It will, of course, be appreciated that there may be one or more intermediary computers or devices between the verification device 1104 and the verification system 1106 that enable communication of data between the verification device 1104 and the verification system 1106. The verification device 1104 may be arranged to communicate with the verification system 1106 via a website or webpage provided by the verification system 1106.

The verification device 1104 may be any data processing device suitable for communicating with the device 1002. The verification device 1104 may, for example, comprise a computer system 900. The verification device 1104 may, for example, be a mobile telephone. The verification device 1104 may be arranged to communicate with the device 1002 via any suitable communication means. For example, the device 1002 may comprise one or more contacts/pads/pins which the verification device 1104 may use (when in contact with those one or more contacts/pad/pins) to receive data from the device 1002 and/or provide data to the device 1002. Alternatively, the device 1002 may be arranged to communicate with the verification device 1104 via a wireless/contactless communication channel (such as near-field-communication, WiFi, Bluetooth, etc.), in which case the device 1002 and the verification device 1104 may comprise any suitable wireless/contactless communication interfaces/components as necessary for carrying out such wireless/contactless communication.

The verification system 1106 may be any data processing system and may, therefore, comprise one or more computer systems 900. For example, the verification system 1106 may comprise one or more servers.

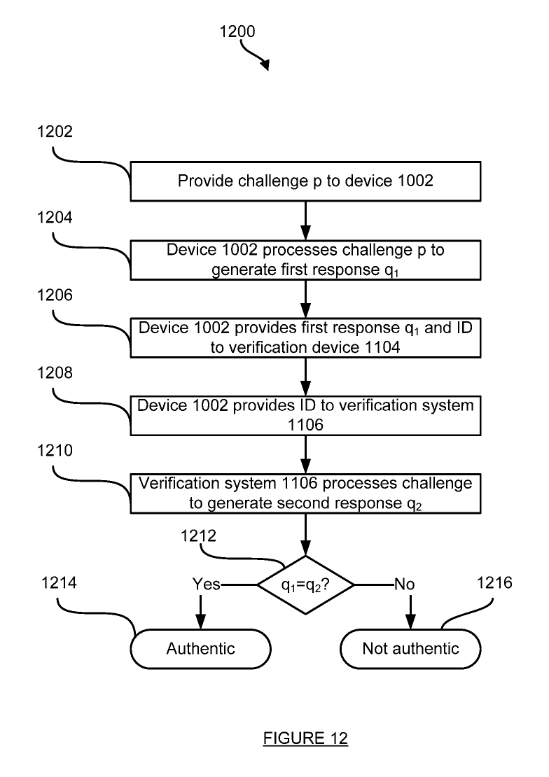

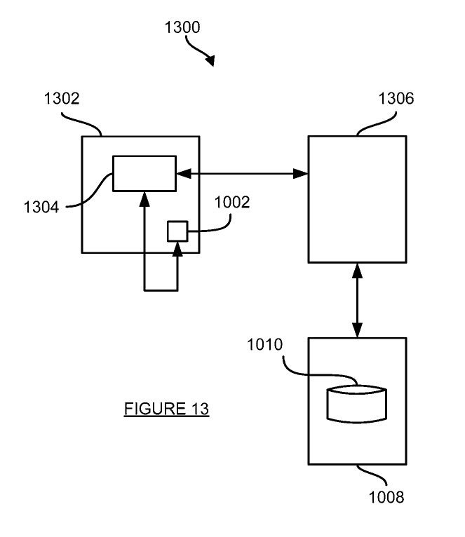

FIG. 12 is a flowchart schematically illustrating a method 1200 carried out using the system 1100 according to an embodiment of the invention. This method may be implemented, in part, by an application or computer program executing on the verification device 1104 and, in part, by an application or computer program executing on the verification system 1106.

At a step 1202 a challenge p is provided by the verification device 1104 to the device 1002. The challenge p may be a randomly generated number or amount of data. The challenge p may be generated by the verification device 1104 or may be generated by the verification system 1106 (which then provided the challenge p to the verification device 1104 for the verification device 1104 to then pass the challenge p on to the device 1002). The challenge p may comprise a number of bits equal to the bit-size of the input data d₁.

At a step 1204, the device 1002 processes the challenge p using the method 100 to generate a first response q₁. For example, if the challenge p comprises a number of bits equal to the bit-size of the input data d₁, then the device 1002 may use the challenge p as the input data d₁, in which case the first response q₁ may be the output of the method 100, i.e. q₁=e_{Nr}.

At a step 1206, the device 1002 provides the first response q₁ and the identifier of the device 1002 (being stored on the device 1002) to the verification device 1104. It will be appreciated that this may be done as one communication/message or that this may be achieved via multiple communications/messages (e.g. with one message comprising the first response q₁ and another different message comprising the identifier). Indeed, it is possible that the identifier may have previously been provided to the verification device 1104 (for example, when the device 1002 and the verification device 1104 establish their communication channel/link).

At a step 1208, the verification device 1104 provides the received identifier to the verification system 1106.

At a step 1210, the verification system 1106 uses the received identifier to determine the corresponding configuration of this specific device 1002. For example, the verification system 1106 may access/query the database 1010 to identify/retrieve the configuration (or key ψ) for the method 100 being implemented by this specific device 1002. The verification system 1106 may then use the configuration to processes the challenge p using the method 100 (as configured by the determined configuration) to generate a second response q₂. In this way, the verification system 1106 aims to mimic processing performed by the device 1002. The step 1210 may involve the verification device 1104 providing the challenge to the verification system 1106 (particularly if it was the verification device 1104 that generated the challenge p in the first place).

At a step 1212, it is determined whether or not the first response q₁ is the same as the second response q₂ (i.e. the first response q₁ is compared to the second response q₂). The step 1212 may be carried out by the verification system 1106 (in which case the method 1200 also involves the verification device 1104 passing the first response q₁ to the verification system 1106, for example at the step 1208). Alternatively, the step 1212 may be carried out by the verification device 1104 (in which case the method 1200 also involves the verification system 1106 passing the second response q₂ to the verification device 1104).

If it is determined, at the step 1212, that the first and second responses q₁ and q₂ are the same, then at a step 1214 one or more steps are taken based on the article 1102 being authentic. For example, if the step 1212 is performed by the verification system 1106, then the step 1214 may comprise the verification system 1106 providing a message or indication to the verification device 1104 to inform the verification device 1104 that the article 1102 is authentic. The step 1214 may comprise the verification device 1104 informing an operator of the verification device 1104 of the successful authentication of the article 1102 (for example by displaying a corresponding message on a screen of the verification device 1104 and/or by outputting a corresponding audio signal).

If it is determined, at the step 1212, that the first and second responses q₁ and q₂ are not the same, then at a step 1216 one or more steps are taken based on the article 1102 not being authentic. For example, if the step 1212 is performed by the verification system 1106, then the step 1214 may comprise the verification system 1106 providing a message or indication to the verification device 1104 to inform the verification device 1104 that the article 1102 is not authentic. The step 1214 may comprise the verification device 1104 informing an operator of the verification device 1104 of the unsuccessful authentication of the article 1102 (for example by displaying a corresponding message on a screen of the verification device 1104 and/or by outputting a corresponding audio signal).

Additional checks may also be performed as part of the verification process. For example, the step 1214 may comprise the verification system 1106 ascertaining whether or not a device 1002 with this particular identifier has been authenticated (in the manner set out above) at multiple different geographical locations within a threshold period of time. If this determination is positive, then the verification system 1106 may conclude that the device 1002 has been cloned or duplicated (with the various clones potentially being used at different locations on different articles in an unauthorised manner), in which case the step 1214 may comprise taking appropriate action to counter the cloning of that device 1002 (e.g. no longer authorizing the use of, or approving/authenticating, a device 1002 with that particular identifier).

The system 1100 may similarly be used to perform tracking/tracing of articles 1102 (e.g. as articles 1102 are being transported between various locations). The method 1200 may be carried out for such tracking/tracing of articles 1102, in which case the step 1214 may comprise the verification system 1106 logging data relating to the article 1102, such as: that the article 1102 (or at least its device 1002) corresponding to the received identifier was at a certain location (namely the location of the verification device 1104); that the article 1102 (or at least its device 1002) corresponding to the received identifier was tested at a certain date/time; etc.

FIG. 13 schematically illustrates a system 1300 according to an embodiment of the invention. The system 1300 may be used to control the use of an item of software, as shall be described in more detail below.

In the system 1300, a data processing device 1302 (such as a computer, mobile telephone, laptop, or any other system 900) has affixed (or applied or attached) thereto, or embedded (or contained) within, a corresponding device 1002. The device 1002 may be attached to the data processing device 1302 in any convenient manner, such as via an adhesive, being integrally formed with the data processing device 1302, being attached via a locking mechanism (e.g. a security pin/tag), etc. Alternatively, the user/operator of the data processing device 1302 may simply have a token (e.g. a key fob, memory stick, USB token, or other portable device) that comprises the device 1302.

The data processing device 1302 is arranged to communicate with the device 1002 via any suitable communication means. For example, the device 1002 may comprise one or more contacts/pads/pins which the data processing device 1302 may use (when in contact with those one or more contacts/pad/pins) to receive data from the device 1002 and/or provide data to the device 1002. Alternatively, the device 1002 may be arranged to communicate with the data processing device 1302 via a wireless/contactless communication channel (such as near-field-communication, WiFi, Bluetooth, etc.), in which case the device 1002 and the data processing device 1302 may comprise any suitable wireless/contactless communication interfaces/components as necessary for carrying out such wireless/contactless communication.

The data processing device 1302 is also arranged to execute (e.g. using one or more processors of the device 1302) a computer program (or item of software) 1304. The intention is that the computer program 1304 should only be run or executed on this particular data processing device 1302 (or if the user of the data processing device 1302 is in possession of a corresponding device 1002)—i.e. if the computer program 1304 were to be copied or transferred to a different data processing device 1302 (or if the user of the data processing device 1302 is not in possession of the correct device 1002) then the computer program 1304 would not execute correctly (i.e. would not provide the desired/normal functionality) on that data processing device 1302.

In order to achieve this, the system 1100 comprises a software provider system 1306. The software provider system 1306 may be arranged to provide the computer program 1304 to the data processing device 1302. This can be achieved via any suitable means (e.g. physical delivery or via a data transfer over a network). Thus, the software provider system 1306 and the data processing device 1302 may be arranged to communicate with each other via any suitable data communication method. For example, the software provider system 1306 and the data processing device 1302 may communicate with each other via a network (not shown in FIG. 13). The network may be any kind of data communication network suitable for communicating or transferring data between the software provider system 1306 and the data processing device 1302. Thus, the network may comprise one or more of: a local area network, a wide area network, a metropolitan area network, the Internet, a wireless communication network, a wired or cable communication network, a satellite communications network, a telephone network, etc. The software provider system 1306 and the data processing device 1302 may be arranged to communicate with each other via the network via any suitable data communication protocol. It will, of course, be appreciated that there may be one or more intermediary computers or devices between the software provider system 1306 and the data processing device 1302 that enable communication of data between the software provider system 1306 and the data processing device 1302. The data processing system 1302 may be arranged to communication with the software provider system 1306 via a website or webpage provided by the software provider system 1306.

The software provider system 1306 may be any data processing system and may, therefore, comprise one or more computer systems 900. For example, the software provider system 1306 may comprise one or more servers. The software provider system 1306 may be arranged to communicate with the configuration storage system 1008 or, alternatively, software provider system 1306 may comprise the configuration storage system 1008.

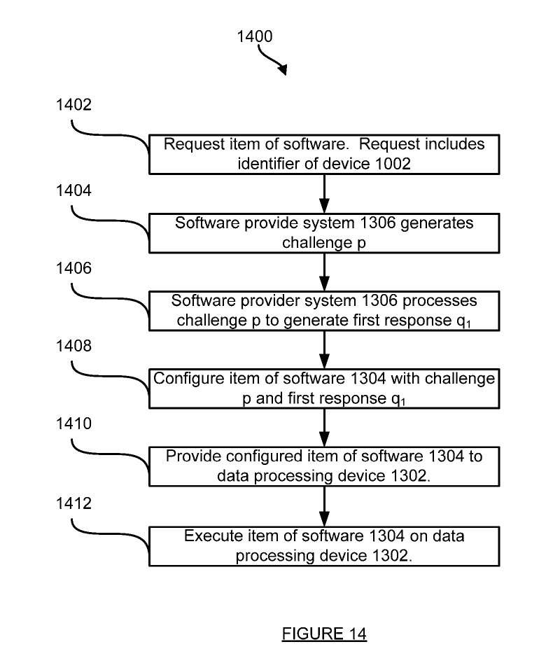

FIG. 14 is a flowchart schematically illustrating a method 1400 carried out using the system 1300 according to an embodiment of the invention.

At a step 1402, the data processing device 1302 sends a request for an item of software to the software provider system 1306. This request comprises an identifier of the device 1002. Thus, the step 1402 may comprise the data processing device 1302 sending a request to the device 1002 for the device's identifier and the device 1002 providing the identifier to the data processing device 1302 in response to that request.

At a step 1404, the software provider system 1306 generates a challenge p. The challenge p may be a randomly generated number or amount of data. The challenge p may comprise a number of bits equal to the bit-size of the input data d₁.

At a step 1406, the software provider system 1306 uses the received identifier to determine the corresponding configuration of the specific device 1002 of the data processing device 1302. For example, the software provider system 1306 may access/query the database 1010 to identify/retrieve the configuration (or key ψ) for the method 100 being implemented by this specific device 1002. The software provider system 1306 may then use the configuration to processes the challenge p using the method 100 (as configured by the determined configuration) to generate a first response q₁. For example, if the challenge p comprises a number of bits equal to the bit-size of the input data d₁, then the software provider system 1306 may use the challenge p as the input data d₁, in which case the first response q₁ may be the output of the method 100, i.e. q₁=e_{Nr}. In this way, the software provider system 1306 aims to mimic processing that would be performed by the device 1002.

At a step 1408, the software provider system 1306 configures the requested item of software 1304 with the challenge p and based on the first response q₁. As shall be described shortly, the item of software 1304 is arranged (when executed by the data processing device 1302) to send the challenge p to the device 1002 and receive a second response q₂ back from the device 1002. Therefore, the software provider system 1306 may be arranged to configure the requested item of software 1304 so that, when it is executed by the data processing device 1302, it compares the received second response q₂ with the known “correct” value for the first response q₁ and (a) if the received second response q₂ equals the first response q₁, then the item of software 1304 performs the intended/normal functionality, whereas (b) if the received second response q₂ does not equal the first response q₁, then the item of software 1304 performs functionality other than the intended/normal functionality (e.g. the item of software 1304 could terminate its own execution, or could provide output data that is meaningless or useless to the operator of the data processing device 1302). Alternatively, the item of software 1304 may not be configured to explicitly compare the received second response q₂ with the known “correct” value for the first response q₁—instead, the software provider system 1306 may configure the item of software 1304 to use the received second response q₂ as an input to one or more calculations/operations, wherein these calculations/operations only provide the correct/intended/normal result if the received second response q₂ equals the first response q₁. For example, an operation in the item of software 1304 may be arranged to process a variable x, in which case the software provider system 1306 may modify that operation so that it processes x* XOR q₂, where x* is configured in the modified item of software 1304 to be equal to x XOR q₁—in this case, the operation will process the variable x (as originally intended) only if q₁=q₂. It will be appreciated that the software provider system 1306 may configure the requested item of software 1304 with the challenge p and based on the first response q₁ (so that the item of software 1304 will only provide its normal/intended/desired functionality if the value of the second response q₂ obtained from the device 1002 in response to the challenge p equals the first response q₁) in any other manner.

At a step 1410, the software provider system 1306 provides the configured item of software 1304 to the data processing device 1302.

At a step 1412, the data processing device 1302 executes the item of software 1304. As explained above, this involves the item of software 1304 (or the data processing device 1302) providing the challenge p contained in the item of software 1304 to the device 1002. The device 1002 processes the challenge p using the method 100 to generate the second response q₁. For example, if the challenge p comprises a number of bits equal to the bit-size of the input data d₁, then the device 1002 may use the challenge p as the input data d₁, in which case the second response q₂ may be the output of the method 100, i.e. q₂=e_{Nr}. The device 1002 provides the second response q₂ back to the item of software 1304 (or the data processing device 1302), and the item of software 1304 then continues execution using the second response q₂.

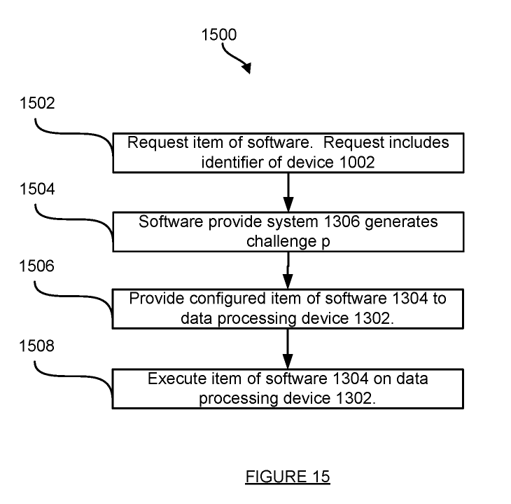

FIG. 15 is a flowchart schematically illustrating another method carried out using the system 1300 according to an embodiment of the invention.

At a step 1502, the data processing device 1302 sends a request for an item of software to the software provider system 1306. This request comprises an identifier of the device 1002. Thus, the step 1502 may comprise the data processing device 1302 sending a request to the device 1002 for the device's identifier and the device 1002 providing the identifier to the data processing device 1302 in response to that request.

At a step 1504, the software provider system 1306 uses the received identifier to determine the corresponding configuration of the specific device 1002 of the data processing device 1302. For example, the software provider system 1306 may access/query the database 1010 to identify/retrieve the configuration (or key ψ) for the method 100 being implemented by this specific device 1002. The software provider system 1306 may then configure the requested item of software 1304 to be able to execute the method 100 using the same configuration as this specific device 1002 (e.g. by including code for performing the method 100 according to this configuration and/or by including the key ψ within the item of software 1304 for use by the item of software 1304). The software provider system 1306 may also configure the requested item of software 1304 so that, when it is executed by the data processing device 1302, to:
(a) Generate a challenge p. The challenge p may be a randomly generated number or amount of data. The challenge p may comprise a number of bits equal to the bit-size of the input data d₁.
(b) Process the challenge p using the method 100 (as contained/encoded within the item of software 1304) to generate a first response q₁. For example, if the challenge p comprises a number of bits equal to the bit-size of the input data d₁, then the item of software 1304 may use the challenge p as the input data d₁, in which case the first response q₁ may be the output of the method 100, i.e. q₁=e_{Nr}.
(c) Issue the challenge p to the device 1002 and receive a second response q₂ from the device 1002. Here, the second response q₂ is the value provided by the device 1002 processing the challenge p.

The software provider system 1306 may configure the item of software 1304 so that the item of software 1304 will only provide its normal/intended/desired functionality if the value of the second response q₂ obtained from the device 1002 in response to the challenge p equal the first response q₁. For example, the software provider system 1306 may be arranged to configure the requested item of software 1304 to compare the received second response q₂ with the first response q₁ and (a) if the received second response q₂ equals the first response q₁, then the item of software 1304 performs the intended/normal functionality, whereas (b) if the received second response q₂ does not equal the first response q₁, then the item of software 1304 performs functionality other than the intended/normal functionality (e.g. the item of software 1304 could terminate its own execution, or could provide output data that is meaningless or useless to the operator of the data processing device 1302). Alternatively, the item of software 1304 may not be configured to explicitly compare the received second response q₂ with the known “correct” value for the first response q₁—instead, the software provider system 1306 may configure the item of software 1304 to use the first and second responses q₁ and q₂ as inputs to one or more calculations/operations, wherein these calculations/operations only provide the correct/intended/normal result if the received second response q₂ equals the first response q₁. For example, an operation of the item of software 1304 may be arranged to process a variable x, in which case the software provider system 1306 may modify that operation so that it processes x XOR q₂ XOR q₁—in this case, the operation the modified/configured item of software 1304 will process the variable x in the intended manner only if q₁=q₂. It will be appreciated that the software provider system 1306 may configure the requested item of software 1304 (so that the item of software 1304 will only provide its normal/intended/desired functionality if the value of the second response q₂ obtained from the device 1002 in response to the challenge p equal the first response q₁) in any other manner.

At a step 1506, the software provider system 1306 provides the configured item of software 1304 to the data processing device 1302.

At a step 1508, the data processing device 1302 executes the item of software 1304. This involves the item of software 1304 (or the data processing device 1302) performing steps (a), (b) and (c) set out above.

As the devices 1002 generated by the system 1000 are all individualized (i.e. carry out the method 100 with their own respective configurations), if the incorrect device 1002 is used with the item of software 1304 (e.g. if the item of software 1304 has been transferred to a different data processing device 1302), then the second response q₂ will not equal the “correct” first response q₁ and the item of software 1304 will not execute with the normal/intended/desired functionality.

The above examples involve using the device 1002 in a challenge-response mechanism, whereby a challenge is issued to the device 1002, the device 1002 processes the challenge using the method 100 to form a response, and subsequent processing (e.g. authentication or continues “correct” execution of an item of software) is performed based on whether or not that response is the response expected from a particular device 1002. It will be appreciated that the method 100 (and the device 1002) may be used to determine responses as part of any challenge-response protocol (which could be the same as, or different from, those set out above) and for any other purposes (not just authenticating articles 1102 or locking execution of items of software 1304 to specific devices 1302). In this way, the devices 1002 may be used to provide respective authenticable unique identifiers, which can be used in a variety of scenarios in which having an identifier is of use.

It will be appreciated that, in embodiments of the invention, the method 100 (and devices 1002 that implement the method 100) may be used encrypt or decrypt data. For example, if two entities A and B share the cryptographic key ψ, then one of them (e.g. A) may use the method 100 (configured according to the cryptographic key ψ) to process one or more blocks of input data d₁ to thereby effectively encrypt those blocks of input data d₁. These encrypted blocks may then be decrypted by the other entity (e.g. B)—each encrypted block could be processed by performing the method 100 (configured according to the cryptographic key ψ) backwards, since the method 100 is an invertible procedure.

It will be appreciated that, in embodiments of the invention, the method 100 (and devices 1002 that implement the method 100) may be used generate a signature or message authentication code (MAC) for an amount of data. For example, if two entities A and B share the cryptographic key ψ, then one of them (e.g. A) may use the method 100 (configured according to the cryptographic key ψ) to process one or more blocks of input data d₁ and combine (e.g. XOR) the processed blocks to form a hash value of the one or more blocks of input data. The one or more blocks of input data may be sent to the other entity (e.g. B) along with the hash value. The other entity (e.g. B) could then perform the same processing on the received one or more blocks of data to generate a second hash—this second hash can then be compared to the received hash and (a) if the two match, a conclusion is reached that the received one or more blocks of data have not been modified and originated from A whilst (b) if the two do not match, a conclusion is reached that either (i) the received one or more blocks of data and/or the hash have been modified and/or (ii) the received one or more blocks of data and/or the hash did not originate from entity A.

### 5—Modifications

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then one or more storage media and/or one or more transmission media storing or carrying the computer program form aspects of the invention. The computer program may have one or more program instructions, or program code, which, when executed by one or more processors (or one or more computers), carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, byte code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A cryptographic method comprising sequentially performing a number of rounds, each round comprising performing a respective round function on respective input data for that round to generate respective output data for that round, wherein for each of the second and subsequent rounds, the input data for that round is the output data of the preceding round, wherein for each round the respective round function comprises:
applying a respective bijective operation to a first amount of data to produce a first result, the bijective operation corresponding to at least part of a cryptographic key; and
processing a second amount of data by applying a plurality of processing operations to produce a second result, wherein at least one of the processing operations is the bijective operation;
wherein the first amount of data and the second amount of data are based on the input for said round and wherein the output data for said round is based on the first result and the second result;
wherein one or both of the following apply:
(a) for each of one or more of the processing operations, that processing operation comprises functionality that is dependent on a respective part of the first result; and
(b) for each of one or more of the processing operations, a number of times that processing operation is applied when processing the second amount of data is dependent on a respective part of the first result.

2. The method of claim 1, wherein said processing operation that is the bijective operation is one of the one or more processing operations for which a number of times that processing operation is applied when processing the second amount of data is dependent on a respective part of the first result.

3. The method of claim 1, wherein at least one of said one or more processing operations that comprises functionality that is dependent on a respective part of the first result is an operation that:
cyclically rotates elements of an input to said operation by a number of elements dependent on said respective part of the first result; or inverts one or more elements of an input to said operation, the one or more elements being selected based on said respective part of the first result.

4. (canceled)

5. The method of claim 3, wherein said elements are bits.

6. The method of claim 1, wherein the bijective operation is arranged to bijectively map an n-bit input value to an n-bit output value by sequentially using Ns sets Sᵢ (i=1, . . . , Ns) of bijective mappings, each set Sᵢ (i=1, . . . , Ns) having a respective number Nbᵢ of respective bijective mappings B_{i,1}, . . . , B_{i,Nb}_{ᵢ}, wherein each bijective mapping B_{i,j} (i=1, . . . , Ns, j=1, . . . , Nbᵢ) is arranged to bijectively map an input with a respective number w_{i,j} of bits to an output with w_{i,j} bits, wherein for i=1, . . . , Ns, Σⱼ₌₁^{Nb}^{ⁱ}w_{i,j}=n, wherein:
for set S₁, the input for the bijective mapping B_{1,j} (j=1, . . . , Nb₁) is formed from w_{1,j} bits from the n-bit input value selected according to at least part of the cryptographic key;
for set Sᵢ (i=2, . . . , Ns), the input for the bijective mapping B_{i,j} (j=1, . . . , Nbᵢ) comprises w_{i,j} bits from the outputs of the bijective mappings B_{i-1,1}, . . . , B_{i-1,Nb}_{ᵢ}₋₁;
the n-bit output value comprises the bits from the outputs of the bijective mappings B_{Ns,1}, . . . , B_{Ns,Nb}_{_{Ns}} arranged according to at least part of the cryptographic key.

7. The method of claim 6, wherein the sets of bijective mappings form a Banyan network.

8. The method of claim 6, wherein the sets of bijective mappings are arranged so that each bit of the n-bit input value affects substantially all of the bits of the n-bit output value.

9. The method of claim 6, wherein:
n=27;
Ns=3;
Nbᵢ=9 (for i=1, 2, 3), and
w_{i,j}=3 (for i=1, 2, 3 and j=1, . . . , 9).

10. The method of claim 6, wherein each bijective mapping B_{i,j} (i=1, . . . , Ns, j=1, . . . , Nbᵢ) is based on at least part of the cryptographic key.

11. The method of claim 1, wherein the output data of said round comprises the first result and the second result.

12. The method of claim 11, wherein the output data of said round comprises N bits, wherein N is an even number and wherein the first result and the second result comprise N/2 respective bits for the output data.

13. The method of claim 1, wherein the input data of said round comprises the first amount of data and the second amount of data.

14. The method of claim 13, wherein the input data of said round comprises N bits, wherein N is an even number and wherein the first amount of data and the second amount of data comprise N/2 bits respective bits from the input data.

15. The method of claim 12, wherein N=54.

16. The method of claim 1, wherein for each round the respective round function further comprises performing a respective bijective function on a respective input chunk of data to generate a respective output chunk of data, wherein the input chunk of data is based on the input for said round and wherein the first amount of data and the second amount of data for said round are based on the output chunk of data.

17. The method of claim 16, wherein the input chunk of data and the output chunk of data are m-bit values, wherein the bijective function uses a respective set of bijective mappings B₁, . . . , B_{Nb}, wherein Nb is a respective positive integer, wherein each bijective mapping Bⱼ (j=1, . . . , Nb) is arranged to bijectively map an input with a respective number wⱼ of bits to an output with wⱼ bits, wherein Σⱼ₌₁^{Nb} wⱼ=m, wherein the input for the bijective mapping Bⱼ (j=1, . . . , Nb) is formed from wⱼ bits from the m-bit input chunk of data and the
m-bit output chunk of data comprises the bits from the outputs of the bijective mappings B₁, . . . , B_{Nb}.

18. The method of claim 17, wherein:
m=54,
Nb=27; and
wⱼ=2 (for j=1, . . . , Nb).

19. The method of claim 17, wherein each bijective mapping Bⱼ (j=1, . . . , Nb) is based on at least part of the cryptographic key.

20. The method of claim 16, wherein the input chunk of data is the input data for said round.

21. A device arranged to perform a cryptographic method, wherein the cryptographic method comprises sequentially performing a number of rounds, each round comprising performing a respective round function on respective input data for that round to generate respective output data for that round, wherein for each of the second and subsequent rounds, the input data for that round is the output data of the preceding round, wherein for each round the respective round function comprises:
applying a respective bijective operation to a first amount of data to produce a first result, the bijective operation corresponding to at least part of a cryptographic key; and
processing a second amount of data by applying a plurality of processing operations to produce a second result, wherein at least one of the processing operations is the bijective operation;
wherein the first amount of data and the second amount of data are based on the input for said round and wherein the output data for said round is based on the first result and the second result;
wherein one or both of the following apply:
(a) for each of one or more of the processing operations, that processing operation comprises functionality that is dependent on a respective part of the first result; and
(b) for each of one or more of the processing operations, a number of times that processing operation is applied when processing the second amount of data is dependent on a respective part of the first result.

22. A method of generating a plurality of devices so that each device is arranged to perform a cryptographic method wherein the cryptographic method comprises sequentially performing a number of rounds, each round comprising performing a respective round function on respective input data for that round to generate respective output data for that round, wherein for each of the second and subsequent rounds, the input data for that round is the output data of the preceding round, wherein for each round the respective round function comprises:
applying a respective bijective operation to a first amount of data to produce a first result, the bijective operation corresponding to at least part of a cryptographic key; and
processing a second amount of data by applying a plurality of processing operations to produce a second result, wherein at least one of the processing operations is the bijective operation;
wherein the first amount of data and the second amount of data are based on the input for said round and wherein the output data for said round is based on the first result and the second result;
wherein one or both of the following apply:
(a) for each of one or more of the processing operations, that processing operation comprises functionality that is dependent on a respective part of the first result; and
(b) for each of one or more of the processing operations, a number of times that processing operation is applied when processing the second amount of data is dependent on a respective part of the first result;
wherein generating the plurality of devices comprises,
for each of the plurality of devices:
determining the round function for each round, wherein the set of determined round functions is specific to said device; and
generating the device, wherein the device is arranged to perform the cryptographic method using the set of determined round functions.

23. The method of claim 22, wherein said generating the device comprises using one of (a) printed electronics; or (b) e-beam lithography.

24. The method of claim 1, the method performed as part of a challenge-response protocol, then method comprising:
receiving a challenge; and
processing the challenge using the rounds to generate a response corresponding the challenge.

25. A method of performing a challenge-response protocol, the method comprising:
generating a challenge; and
providing the challenge to a device arranged to process the challenge using a cryptographic method according to claim 1 to generate a response corresponding the challenge;
receiving the response from the device.

26. The method of claim 25, wherein the device is associated with an article, the method further comprising
determining whether the response is an expected response to thereby determine authenticity of the article.

27. The method of claim 25 wherein the method is carried out during execution of an item of software on a data processor and wherein subsequent execution of the item of software is based, at least in part, on the received response.

28. (canceled)

29. (canceled)

30. (canceled)

31. The method of claim 14, wherein N=54.
